(19) United States
(12) Patent Application Publication
(10) Pub. No.: US 2006/0104173 A1
(43) Pub. Date: May 18, 2006

(54) Method of detecting focus error signal of optical head and optical head and optical recording/reproducing apparatus utilizing the same

(75) Inventors: Giichi Shibuya, Tokyo (JP); Teiichiro Oka, Tokyo (JP)

Correspondence Address: OLIFF & BERRIDGE, PLC, P.O. BOX 19928, ALEXANDRIA, VA, 22320, US

(73) Assignee: TDK Corporation, Tokyo (JP)

(21) Appl. No.: 11/266,432

(22) Filed: Nov. 4, 2005

(30) Foreign Application Priority Data
Nov. 16, 2004 (JP) 2004-331571

(51) Int. Cl. G11B 7/00

(52) U.S. Cl. 369/44.37; 369/44.41

(57) ABSTRACT

The invention relates to a method of detecting a focus error signal of an optical head to be used for adjusting the position of an objective lens for converging a light beam on an optical recording medium and to an optical head and an optical recording/reproducing apparatus employing the method. The invention provides a method of detecting a focus error signal of an optical headwhich allows a focus error signal to be detected with track cross signals therein attenuated from a plural types of optical recording media having different physical track pitches and an optical head and an optical recording/reproducing apparatus employing the method. A main beam reflected by an optical recording medium is received by a light-receiving element, and electrical signals output from four light receiving regions of the element are used to generate a focus error signal MFES based on the main beam according to astigmatic focus error detection and a push-pull signal MPS based on the main beam according to the push-pull method. An error signal detection unit subtracts the MPS from the MFES to detect a focus error signal FES from which track cross signals have been attenuated.

### BACKGROUND OF THE INVENTION

1. Field of the Invention

The present invention relates to a method of detecting a focus error signal of an optical head used to adjust the position of an objective lens for converging a light beam on an optical recording medium, and the invention also relates to an optical head and an optical recording/reproducing apparatus employing the method.

2. Description of Related Art

An optical recording/reproducing apparatus includes an optical head which records information in predetermined regions of a plurality of tracks formed in the radial direction of an optical recording medium so as to extend along the circumferential direction of the optical recording medium that is in the form of, for example, a disk and which reproduces information recording in predetermined regions of the tracks. Optical heads include record-only types used only for recording information on an optical recording medium, reproduction-only types used only for reproducing information, and recording/reproduction types which can be used for both of recording and reproduction. Apparatus loaded with those types of optical heads constitute optical recording apparatus, optical reproducing apparatus, and optical recording/reproducing apparatus, respectively, and all of such apparatus are collectively referred to as optical recording/reproducing apparatus in the present specification.

Differential astigmatic focus error detection is known as a method of detecting a focus error signal (FES) for controlling the focal position of an objective lens (focal position adjustment) used in an optical head provided in an optical recording/reproducing apparatus. Patent Documents 1 to 3 disclose methods of differential astigmatic focus error detection. Differential astigmatic focus error detection is characterized in that it makes it possible to reduce track cross signal components included in a focus error signal, the components being generated when an objective lens moves across a track of an optical recording medium. According to the differential astigmatic focus error detection, a light beam emitted by a light source is split by a diffraction grating into a main beam and two sub beams which are then converged and reflected on a surface of an optical recording medium information recording surface. A focus error signal is generated according to astigmatic focus error detection from each of the main beam and two sub beams thus reflected, and a focus error signal obtained by adding the focus error signals is used for controlling the focal position of the objective lens.

As seen on DVD-RAMs that are in practical use, in the case of an optical recording medium employing the land/groove recording method in which information is recorded in both of lands and grooves, a physical track pitch of the optical recording medium is twice a data track pitch. An optical recording medium employing the land/groove recording method will therefore provide a track cross signal having higher contrast when compared to optical recording media employing other methods of recording. It is therefore important for an optical recording medium employing the land/groove recording method to sufficiently reduce track cross signals included in a focus error signal using differential astigmatic focus error detection.

The differential push-pull method which has been frequently used is known as a method of detecting a tracking error signal used to cope with a tracking error of an objective lens. Patent Documents 4 and 5 disclose approaches based on the differential push-pull method. According to the differential push-pull method, a main beam and two sub beams reflected by an optical recording medium are received by separate light-receiving elements; a push-pull signal is detected from each of the main beam and the two sub beams; and differential operation is performed on the push-pull signals. Thus, DC offset components generated by shifts of the objective lens in the radial direction of the medium can be preferably eliminated from a tracking error signal. The differential push-pull method is widely used because it is effective especially for tracking control in an unrecorded area which is required in a recording mode.

In either of differential astigmatic focus error detection and differential push-pull method, the positions of the spots of sub beams relative to the position of the spot of a main beam in the radial direction of an information recording surface of an optical recording medium must be set such that the intervals between the spots become ½ times the physical track pitch of the medium. The term “physical track pitch” means a length corresponding to one period of a track cross signal obtained from reproduction using an optical head, and the physical track pitch is twice a data track pitch in DVD-RAMs and is the same length as a data track pitch in other optical recording media including DVD-ROMs.

Patent Document 1: JP-A-4-163681

Patent Document 2: JP-A-11-296875

Patent Document 3: JP-A-12-82226

Patent Document 4: JP-B-4-34212

Patent Document 5: JP-A-7-320287

Patent Document 6: JP-A-2004-63073

Patent Document 7: JP-A-10-64080

Patent Document 8: JP-A-2001-222827

In the present field of optical recording/reproducing apparatus which are becoming more and more diversified according to demands in the market, no universal standard has been agreed on optical recording media, and products according to a plurality of standards are therefore being proposed and put in practical use. Under the circumstance, there is sometimes a need for recording and reproducing optical recording media having different physical track pitches using one and the same optical head. FIGS. 14A to 15C schematically show a main beam 101 and sub beams 103a and 103b of orders of ±1 converged on an information recording surface of an optical recording medium. FIGS. 14A and 15A show an information recording surface of a DVD-RAM. FIGS. 14B and 15B show an information recording surface of a DVD-RW, and FIGS. 14C and 15C show an information recording surface of a DVD-ROM. The arrows R extending in the horizontal direction of FIGS. 14A to 15C represent the radial direction of the optical recording media, and the arrows T extending in the vertical direction of the figures represent a direction tangential to a track of the optical recording media.

As shown in FIGS. 14A and 14B, DVD-RAM and DVD-RW, which are rewritable optical recording media among the family of DVDs, have different physical track pitches P1=1.23 μm and P2=0.74 μm, respectively, the track pitches having influence on a track cross signal. DVD-ROMS, which are used only for reproduction among the DVD family, have a physical track pitch P2=0.74 μm similarly to a DVD-RW.

In order to obtain an idealistic focus error signal by eliminating track cross signals using differential astigmatic focus error detection as described above, each of the beam intervals (spot intervals) between the main beam 101 and the sub beams 103a and 103b in the radial direction must be set at ½ times the physical track pitch. Therefore, in order to obtain an idealistic focus error signal especially from a DVD-RAM on which the occurrence of track cross signal components is significant, the main beam 101 and the sub beams 103a and 103b are idealistically set at a beam interval BP1 of 0.615 μm.

However, as shown in FIGS. 14B and 14C, the optimum beam interval BP1=0.615 μm of a DVD-RAM does not agree with an optimum beam interval BP2=0.37 μm of a DVD-RW or DVD-ROM. Therefore, a focus error signal detected from the main beam 101 and the sub beams 103a and 103b at the beam interval BP1=0.615 μm using differential astigmatic focus error detection is difficult to use in a DVD-RW.

For example, when the spot interval between the main beam 101 and the sub beams 103a and 103b in the radial direction is set at the optimum beam interval BP1 for a DVD-RAM as shown in FIGS. 14A and 14B, the ratio of the beam interval BP1 to the physical track pitch P2 of a DVD-RW is BP1/P2 equals 0.615 μm/0.74 μm=0.831. Since the beam interval BP1 does not agree with ½ times the physical track pitch P2 of a DVD-RW, a track cross signal cannot be satisfactorily eliminated from a focus error signal even when differential astigmatic focus error detection is used.

When the beam interval between the main beam 101 and the sub beams 103a and 103b in the radial direction is set at the optimum beam interval BP2=0.37 μm for a DVD-RW as shown in FIGS. 15A and 15B, the ratio of the beam interval BP2 to the physical track pitch P1 of a DVD-RAM is BP2/P1 equals 0.37 μm/1.23 μm=0.300. Since the beam interval BP2 does not agree with ½ times the physical track pitch P1 of a DVD-RAM, a track cross signal cannot be satisfactorily eliminated from a focus error signal even when differential astigmatic focus error detection is used.

The differential push-pull (DPP) method disclosed in Patent Document 4 is preferably to be used for tracking control on an unrecorded DVD±R/RW medium. However, a beam interval suitable for the DPP method is 0.37 μm as described above. Therefore, when the positions of the spots of the main beam 101 and the sub beams 103a and 103b of orders of ±1 are adjusted to the beam interval BP2=0.37 μm, a deviation from the optimum value of 0.615 μm of the beam interval BP1 occurs at the time of reproduction of a DVD-RAM. As a result, the amplitude of track cross signals included in the sub beams 103a and 103b of orders of ±1 is reduced.

FIG. 16 shows a configuration of light-receiving regions of light-receiving elements 123, 125a, and 125b for receiving the main beam 101 and the sub beams 103a and 103b of orders of ±1. As shown in FIG. 16, a square light-receiving area of the light-receiving element 123 is divided by a division line 124 that is substantially in parallel with a tangent to a track of an optical recording medium (not shown in FIG. 16) and a division line 124′ that is substantially orthogonal to the division line 124. Thus, the element has four square light-receiving regions A, B, C, and D disposed adjacent to each other in the form of a matrix. The light-receiving region A is disposed such that it adjoins the light-receiving region D and the light-receiving region B through the division line 124 and the division line 124′, respectively, and such that it is located diagonally to the light-receiving region C. The light-receiving region C is disposed such that it adjoins the light-receiving region B and the light-receiving region D through the division line 124 and the division line 124′, respectively.

Similarly, a square light-receiving area of the light-receiving element 125a is divided by a division line 126 that is substantially in parallel with the tangent to a track of the optical recording medium and a division line 126′ that is substantially orthogonal to the division line 126. Thus, the element has four square light-receiving regions E1, F1, G1, and H1 disposed adjacent to each other in the form of a matrix. The light-receiving region E1 is disposed such that it adjoins the light-receiving region H1 and the light-receiving region F1 through the division line 126 and the division line 126′, respectively, and such that it is located diagonally to the light-receiving region G1. The light-receiving region GI is disposed such that it adjoins the light-receiving region F1 and the light-receiving region H1 through the division line 126 and the division line 126′, respectively.

Similarly, a square light-receiving area of the light-receiving element 125b is divided by a division line 128 that is substantially in parallel with the tangent to a track of the optical recording medium and a division line 128′ that is substantially orthogonal to the division line 28. Thus, the element has four square light-receiving regions E2, F2, G2, and H2 disposed adjacent to each other in the form of a matrix. The light-receiving region E2 is disposed such that it adjoins the light-receiving region H2 and the light-receiving region F2 through the division line 128 and the division line 128′, respectively, and such that it is located diagonally to the light-receiving region G2. The light-receiving region G2 is disposed -such that it adjoins the light-receiving region F2 and the light-receiving region H2 through the division line 128 and the division line 128′, respectively.

The light-receiving elements 123, 125a, and 125b are slightly offset from each other in the tangential direction of the track to accommodate offsets of optical paths attributable to differences between the positions of spots formed by the main beam 101 and the sub beams 103a and 103b of orders of ±1 on the information recording surface of the optical recording medium. The division lines 124, 126, and 128 are provided substantially in parallel with each other, and the division lines 124′, 126′, and 128′ are provided substantially in parallel with each other. The main beam 101 and the sub beams 103a and 103b of orders of ±1 are converged substantially in the middle of the light-receiving regions of the light-receiving elements 123, 125a, and 125b.

A focus error signal (FES) is detected using differential astigmatic focus error detection using electrical signals output by the light-receiving elements 123, 125a, and 125b. Let us assume now that electrical signals output by the light-receiving regions A to D, E1 to H1, and E2 to H2 are represented by A to D, E1 to H1, and E2 to H2, respectively. Then, the focus error signal can be expressed as follows.
FES={(A+C)−(B+D)}+k×{(E+G)−(F+H)} Expression 1

Where E1+E2=E; F1+F2=F; G1+G2=G; and H1+H2=H, which applies not only to Expression 1 but also to expressions shown below.

FIG. 17 shows changes in the amplitude of a track cross signal included in the sub beams 103a and 103b of orders of ±1 with respect to the beam interval between the main beam 101 and the sub beams 103a and 103b of orders of ±1 in the radial direction of the optical recording medium. The abscissa axis represents the beam interval between the main beam 101 and the sub beams 103a and 103b of orders of ±1 in terms of the ratio of the same to the physical track pitch of the optical recording medium, and the ordinate axis represents the amplitude (in arbitrary unit) of the track cross signal. The vertical broken line in FIG. 17 represents the ratio of the beam interval to the physical track pitch of a DVD-RAM when the beam interval between the main beam 101 and the sub beams 103a and 103b of order of ±1 is the optimum value for a DVD±R/RW (the beam interval=0.37 μm).

When the beam interval is set at 0.37 μm as shown in FIG. 17, the ratio of the beam interval to the physical track pitch of a DVD±R/RW is 0.5 at which a maximum amplitude of the track cross signal can be achieved. However, the ratio of the beam interval to the physical track pitch of a DVD-RAM is 0.3 as indicated by the broken line in the figure, and the amplitude of the track cross signal is as small as about 30% of the maximum amplitude in this case.

For example, let us assume that the ratio of the optical energy of the main beam 101 to that of the sub beams 103a and 103b of orders of ±1 is 18:1 and that the ratio of the photoelectrical conversion gain (amplification factor) of the light-receiving element 123 to that of the light-receiving elements 125a and 125b is 1:3.74. Then, an optimum value of the coefficient k can be calculated as follows using Expression 1 when it is attempted to obtain a differential astigmatic signal (focus error signal) in which track cross signals have been attenuated.
(18×1)÷(1×2×3.74)×(1/0.3)=8

Thus, the coefficient k must be set at a value of about 8. Therefore, an amplification circuit having a high gain must be used an optical recording/reproducing apparatus, and the resultant signal to noise ratio (S/N ratio) will below. Further, a peak value of the electrical signal output based on the sub beams 103a and 103b of orders of ±1 (k}(E+G)−(F+H)} calculated using astigmatic focus error detection may be saturated with reference to the output voltage range of the amplification circuit. As thus described, when the sub beams 103a and 103b are adjusted to positions (beam intervals) that are greatly shifted from the optimum value, a problem arises in that the differential astigmatic focus error detection according to the related art expressed by Expression 1 does not work preferably.

Several embodiments of methods of eliminating track cross components from a focus error signal have been disclosed. The method disclosed in Patent Document 6 is a method called differential astigmatic focus error detection in which an astigmatic signal from a main beam and astigmatic signals from sub beams are added to eliminate track cross components included in a focus error signal in phase opposition to the signal while increasing the amplitude of the S-shaped curve of the focus error signal. The method is widely used for optical heads for DVDS.

According to the method disclosed in Patent Document 7, a tangential push-pull signal is subtracted from an astigmatic signal according to the related art to eliminate track cross components attributable to an optical axis offset in the same direction, whereby the same purpose as described above is achieved.

Further, according to the method disclosed in Patent Document 8, a radial push-pull signal is subtracted from an astigmatic signal according to the related art to eliminate track cross signal components. In this example, a comparison and discussion of eliminating performance is made between a case in which the radial push-pull signal to be subtracted is generated from a main beam and a case in which the signal is generated from sub beams. The conclusion is that it is preferable to prepare the two types of subtraction signals and to switch them appropriately for use because track cross components included in an astigmatic signal are at various phase differences from the signal depending on systems from which the components originate.

However, the differential astigmatic focus error detection in Patent Document 6 has a problem when applied to an optical recording medium having a plurality of physical track pitches. Further, it is not easy to adjust three beams in total, i.e., a main beam and sub beams such that they are located in the middle of patterns in the form of four square divisions of respective light-receiving elements. Since the adjusting step requires facility at a high cost and an excessively long time, there will be an increase in manufacturing cost.

According to the method of subtracting a tangential push-pull signal disclosed in Patent Document 7, track cross signals having amplitude smaller than that of signals included in an astigmatic signal are subtracted as will be described later with reference to FIG. 8. Since it is therefore necessary to set the gain coefficient k at a great value, a problem arises in that degradation of the S/N ratio of a signal will occur.

According to the method of subtracting a push-pull signal disclosed in Patent Document 8, track cross signals having a great amplitude are subtracted, and the value of the gain coefficient k can be small as will be described later with reference to FIG. 8, which is advantageous in achieving a high S/N ratio of a signal. However, since a DC offset of a push-pull signal is generated when the objective lens is shifted in the radial direction of the disk, the DC offset component is applied to a focus error signal if the signal is subtracted as it is. When this signal is used for focus control, no problem occurs if tracking control is not performed. However, when an optical beam follows up a track, i.e., when tracking control is performed, a focus error (defocus) is caused by a shift of the objective lens attributable to displacement of the disk in the direction of the tracks, which results in the problem of degradation of a reproduction signal quality.

### SUMMARY OF THE INVENTION

It is an object of the invention to provide a method of detecting a focus error signal of an optical head which makes it possible to detect a focus error signal while attenuating track cross signals from a plurality of optical recording media having different physical track pitches, and the invention also provides an optical head and an optical recording/reproducing apparatus employing the method.

The above-described object is achieved by a method of detecting a focus error signal of an optical head, characterized in that it comprises the steps of:

diffracting a light beam emitted by a light source to split it into a main beam and two sub beams and converging the beams on an optical recording medium through an objective lens;

converting the main beam and the two sub beams reflected by the optical recording medium into electrical signals by receiving them using three light-receiving areas which are divided into four regions by a first division line substantially in parallel with a direction along a tangent to a track of the optical recording medium and a second division line substantially orthogonal to the first division line; and

detecting a focus error signal in which a track cross signal generated when the objective lens moves across a track of the optical recording medium has been attenuated by subtracting a second arithmetic signal generated by performing an arithmetic process on the main beam and the two sub beams from a first arithmetic signal obtained by performing a differential operation between the electrical signals output by one of diagonal pairs of the light -receiving areas and output by the other pair of the light-receiving areas, respectively,

The invention provides a method of detecting a focus error signal of an optical head according to the above invention, characterized in that it comprises the step of receiving the two sub beams reflected by the optical recording medium using two respective light-receiving areas divided into two regions by the first division line instead of the light-receiving areas divided into four regions to detect the focus error signal in which the track cross signal has been attenuated.

The invention provides a method of detecting a focus error signal of an optical head according to the above invention, characterized in that the focus error signal in which the track cross signal has been attenuated is detected by adding the electrical signals output from the regions located in the same relative position in the light-receiving areas receiving the two sub beams respectively.

The invention provides a method of detecting a focus error signal of an optical head according to the above invention, characterized in that, on the optical recording medium (a first optical recording medium) having a physical track pitch P1 in the radial direction of the same or the optical recording medium (a second optical recording medium) having a physical track pitch P2 (P2<P1), the focus error signal in which the track cross signal has been attenuated is detected by positioning the spots of the two sub beams symmetrically about the spot of the main beam and in positions at a distance of about P2×(n+½) in the radial direction where n represents 0 or a greater integer.

The invention provides a method of detecting a focus error signal of an optical head according to the above invention, characterized in that the focus error signal in which the track cross signal has been attenuated is detected by subtracting the second arithmetic signal from the first arithmetic signal after amplifying the second signal by a predetermined amount based on the ratio of the track cross signal included in each of the first and the second arithmetic signals.

The above-described object is achieved by an optical head diffracting a light beam emitted by a light source to split it into a main beam and two sub beams and converging the beams on an optical recording medium through an objective lens, characterized in that it comprises:

a light-receiving area for the main beam divided into four regions by a first division line substantially in parallel with a direction along a tangent to a track of the optical recording medium and a second division line substantially orthogonal to the first division line for receiving the main beam reflected by the optical recording medium and converting it into an electrical signal; and

two light-receiving areas divided into two regions by the first division line for receiving the two sub beams reflected by the optical recording medium respectively and in that, on the optical recording medium (a first optical recording medium) having a physical track pitch P1 in the radial direction of the same or the optical recording medium (a second optical recording medium) having the physical track pitch P2 (P2<P1), the spots of the two sub beams are positioned symmetrically about the spot of the main beam and in positions at a distance of about P2×(n+½) in the radial direction wheren represents o or a greater integer.

The invention provides an optical head according to the above invention characterized in that the diameter of the spots of the two sub beams formed on a surface of the optical recording medium in the radial direction of the optical recording medium is 2.5 times or more of the diameter of the spot of the main beam in the same direction.

The above-described object is achieved by an optical recording/reproducing apparatus characterized in that it comprises:

an optical head having a diffraction grating for diffracting a light beam emitted by a light source to split it into a main beam and two sub beams, and objective lens for converging the main beam and the two sub beams on an optical recording medium, and three light-receiving areas divided into four regions by a first division line substantially in parallel with a direction along a tangent to a track of the optical recording medium and a second division line substantially orthogonal to the first division line for receiving the main beam and the two sub beams reflected by the optical recording medium and converting them into electrical signals, respectively; and

an error signal detection unit for detecting a focus error signal in which a track cross signal generated when the objective lens moves across a track of the optical recording medium has been attenuated by subtracting a second arithmetic signal generated by performing an arithmetic process on the main beam and the two sub beams from a first arithmetic signal obtained by performing a differential operation between the electrical signals output by one of diagonal pairs of the light-receiving areas and output by the other pair of the light-receiving areas, respectively.

The invention provides an optical recording/reproducing apparatus according to the above invention, characterized in that the optical head includes two light-receiving areas divided into two regions by the first division line for receiving the two sub beams reflected by the optical recording medium respectively instead of the light-receiving areas divided into four regions.

The invention provides an optical recording/reproducing apparatus according to the above invention, characterized in that the error signal detection unit detects the focus error signal in which the track cross signal has been attenuated by adding the electrical signals output from light-receiving regions located in the same relative position in the light-receiving areas receiving the two sub beams respectively.

The invention provides an optical recording/reproducing apparatus according to the above invention, characterized in that the error signal detection unit detects the focus error signal in which the track cross signal has been attenuated by subtracting the second arithmetic signal from the first arithmetic signal after amplifying the second signal by a predetermined amount based on the ratio of the track cross signal included in each of the first and the second arithmetic signals.

The invention provides an optical recording/reproducing apparatus according to the above invention, characterized in that, on the optical recording medium (a first optical recording medium) having a physical track pitch P1 in the radial direction of the same or the optical recording medium (a second optical recording medium) having the physical track pitch P2 (P2<P1), the spots of the two sub beams are positioned symmetrically about the spot of the main beam and in positions at a distance of about P2×(n+½) in the radial direction where n represents 0 or a greater integer.

The invention provides an optical recording/reproducing apparatus according to the above invention, characterized in that the diameter of the spots of the two sub beams formed on a surface of the optical recording medium in the radial direction of the optical recording medium is 2.5 times or more of the diameter of the spot of the main beam in the same direction.

The invention makes it possible to provide an optical recording/reproducing apparatus capable of detecting a focus error signal in which track cross signals have been attenuated from a plurality of optical recording media having different physical track pitches.

### BRIEF DESCRIPTION OF THE DRAWINGS

FIG. 1 shows a schematic configuration of an optical head 1 provided in an optical recording/reproducing apparatus 150 in a first embodiment of the invention;

FIG. 2 shows a configuration of light-receiving portions of light-receiving elements 23, 25a, and 25b of the optical head 1 provided in the optical recording/reproducing apparatus 150 in the first embodiment of the invention and connections between the light-receiving elements 23, 25a, and 25b and an error signal detection unit 31;

FIG. 3 shows a set value of the interval between spots of a main beam 27 and sub beams 29a and 29b of orders of ±1 from the optical head 1 provided in the optical recording/reproducing apparatus 150 in the first embodiment of the invention;

FIG. 4 shows measured waveforms of tangential push-pull signals obtained using the tangential push-pull method to explain the principle of detection of a focus error signal performed by the optical recording/reproducing apparatus 150 in the first embodiment of the invention;

FIG. 5 shows measured waveforms of focus error signals obtained using astigmatic focus error detection to explain the principle of detection of a focus error signal performed by the optical recording/reproducing apparatus 150 in the first embodiment of the invention;

FIGS. 6A and 6B show examples of states of a main beam 27 converged on the light-receiving element 23 to explain the principle of detection of a focus error signal performed by the optical recording/reproducing apparatus 150 in the first embodiment of the invention;

FIG. 7 shows measured waveforms of push-pull signals obtained using the push-pull method to explain the principle of detection of a focus error signal performed by the optical recording/reproducing apparatus 150 in the first embodiment of the invention;

FIG. 8 shows maximum values of the amplitude of track cross signals included in arithmetic signals obtained by various methods of calculation to explain the principle of detection of a focus error signal performed by the optical recording/reproducing apparatus 150 in the first embodiment of the invention;

FIG. 9 shows an FES detecting portion 33 provided in the error signal detection unit 31 of the optical recording/reproducing apparatus 150 in the first embodiment of the invention;

FIG. 10 shows a TES detecting portion 44 provided in the error signal detection unit 31 of the optical recording/reproducing apparatus 150 in the first embodiment of the invention;

FIG. 11 shows a schematic configuration of the optical recording/reproducing apparatus 150 in the first embodiment of the invention;

FIG. 12 shows an FES detecting portion 53 provided in an error signal detection unit 31 of an optical recording/reproducing apparatus 150 in a second embodiment of the invention;

FIG. 13 shows a configuration of light-receiving portions of light-receiving elements 23, 55a, and 55b of an optical head 1 provided in an optical recording/reproducing apparatus 150 in a third embodiment of the invention and connections between the light-receiving elements 23, 55a, and 55b and an error signal detection unit 31;

FIGS. 14A, 14B, and 14C schematically show light beams converged on an information recording surface of an optical recording medium used with an optical head according to the related art;

FIGS. 15A, 15B, and 15C schematically show light beams converged on an information recording surface of an optical recording medium used with an optical head according to the related art;

FIG. 16 shows a configuration of light-receiving portions of light-receiving elements 123, 125a, and 125b of an optical head according to the related art; and

FIG. 17 shows changes in the amplitude of a track cross signal included in sub beams 103a and 103b of orders of ±1 with respect to the beam interval between a main beam 101 and the sub beams 103a and 103b of orders of ±1 from an optical head according to the related art.

### DESCRIPTION OF THE PREFERRED EMBODIMENTS

### First Embodiment

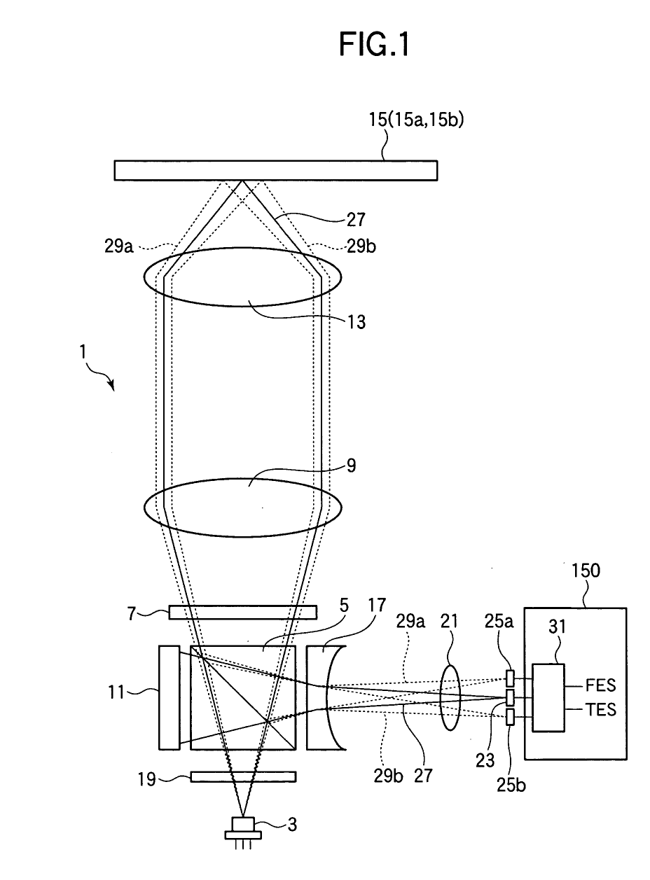

A description will now be made with reference to FIGS. 1 to 11 on a method of detecting a focus error signal of an optical head and on an optical head and an optical recording/reproducing apparatus utilizing the method according to a first embodiment of the invention. A schematic configuration of an optical head 1 provided in an optical recording/reproducing apparatus 150 according to the present embodiment will be first described with reference to FIGS. 1 to 3. The optical head 1 of the present embodiment allows information to be recorded or reproduced on or from each of two types of optical recording media 15 having different physical track pitches. One of the optical recording media 15 (a first optical recording medium 15a) which has a relatively great physical track pitch is a DVD-RAM or an optical recording medium equivalent to a DVD-RAM in physical track pitch. The other optical recording medium 15 (a second optical recording medium 15b) which has a relatively small physical track pitch is a DVD-ROM or DVD±R/RW or an optical recording medium equivalent to them in physical track pitch. The first optical recording medium 15a has a physical track pitch P1 of 1.23 μm, and the second optical recording medium 15b has a physical track pitch P2 of 0.74 μm.

As shown in FIG. 1, the optical head 1 includes a laser diode 3 as a light source that emits light beams. The laser diode 3 can emit light beams having different optical intensities for recording and reproduction, respectively, based on control voltages from a controller (not shown).

A diffraction grating 19 is disposed in a predetermined position on a light exit side of the laser diode 3. A light beam emitted by the laser diode 3 enters the diffraction grating 19 to be split into three light beams (a main beam 27 of order of 0 and sub beams 29a and 29b of orders of ±1). The sub beams 29a and 29b of orders of ±1 are located on an information recording surface of the optical recording medium 15 at a predetermined distance from each other in the directions of a track and a radial, respectively, in a symmetrical relationship about the position of the main beam 27.

A polarization beam splitter 5, a quarter-wave plate 7, a collimator lens 9, and an objective lens 13 are disposed on a light-transmitting side of the diffraction grating 19 as viewed from the laser diode 3, the elements being listed in the order of their closeness to the diffraction grating. The collimator lens 9 is provided to convert a divergent bundle of rays from the laser diode 3 into a parallel pencil of rays which is then guided to the objective lens 13 and to convert a parallel pencil of rays from the objective lens 13 into a convergent pencil of rays which is then guided to light-receiving elements 23, 25a, and 25b. The objective lens 13 converges a parallel pencil of rays from the collimator lens 9 on the information recording surface of the optical recording medium 15 to form a read spot, and the lens is also provided to convert reflected light from the optical recording medium 15 into a parallel pencil of rays which is then guided to the collimator lens 9.

A sensor lens 17, a cylindrical lens 21, and light-receiving elements 23, 25a, and 25b are disposed on a light-reflecting side of the polarization beam splitter 5 as viewed from the quarter-wave plate 7, the elements being listed in the order of their closeness to the beam splitter. A power-monitoring photodiode 11 for measuring the optical intensity of a light beam emitted by the laser diode 3 is disposed on a light-reflecting side of the polarization beam splitter 5 as viewed from the laser diode 3.

The sensor lens 17 serves as a reflected light focusing position adjusting portion for optically adjusting focusing positions of the main beam 27 and the sub beams 29a and 29b of orders of ±1 reflected by the optical recording medium 15. The sensor lens 17 expands the main beam 27 and the sub beams 29a and 29b of orders of ±1 reflected by the optical recording medium 15 at a predetermined optical magnification and forms their images separately on the light-receiving elements 23, 25a, and 25b, respectively, through the cylindrical lens 21. The light-receiving element 23 receives the main beam 27. The light-receiving element 25a receives the sub beam 29a of order of ±1. The light-receiving element 25b receives the sub beam 29b of order of -1.

Electrical signals obtained as a result of photoelectrical conversion at the light-receiving elements 23, 25a, and 25b are input to an error signal detection unit 31 provided in the optical recording/reproducing apparatus 150. Based on the main beam 27 and the sub beams 29a and 29b of orders of ±1 reflected by the optical recording medium 15, the error signal detection unit 31 detects a focus error signal (FES) in which a track cross signal generated by a movement of the objective lens 13 across a track of the optical recording medium 15 has been attenuated and detects a tracking error signal (TES) from which DC offset components caused by shifts of the objective lens 13 in the radial direction of the optical recording medium 15 have been eliminated.

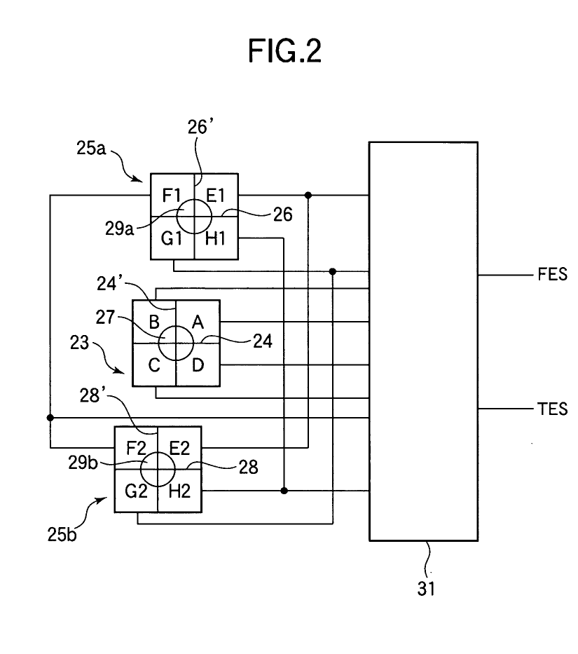

FIG. 2 shows a configuration of light-receiving portions of the light-receiving elements 23, 25a, and 25b and connections between the light-receiving elements 23, 25a, and 25b and the error signal detection unit 31. As shown in FIG. 2, a square light-receiving area of the light-receiving element 23 is divided by a division line (a first division line) 24 that is substantially in parallel with a direction tangential to the tracks of the optical recording medium 15 (not shown in FIG. 2) and a division line (a second division line) 24′ that is substantially orthogonal to the division line 24. Thus, the light-receiving element 23 has four square light-receiving regions (light-receiving regions for the main beam) A, B, C, and D disposed adjacent to each other in the form of a matrix. The light-receiving region A is disposed such that it adjoins the light-receiving region D and the light-receiving region B through the division line 24 and the division line 24′, respectively, and such that it is located diagonally to the light-receiving region C. The light-receiving region C is disposed such that it adjoins the light-receiving region B and the light-receiving region D through the division line 24 and the division line 24′, respectively.

Similarly, a square light-receiving area of the light-receiving element 25a is divided by a division line (a first division line) 26 that is substantially in parallel with the tangent to a track of the optical recording medium 15 and a division line (a second division line) 26′ that is substantially orthogonal to the division line 26. Thus, the light-receiving element 25a has four square light-receiving regions E1, F1, G1, and H1 disposed adjacent to each other in the form of a matrix. The light-receiving region E1 is disposed such that it adjoins the light-receiving region G1 and the light-receiving region F1 through the division line 26 and the division line 26′, respectively, and such that it is located diagonally to the light-receiving region G1. The light-receiving region G1 is disposed such that it adjoins the light-receiving region F1 and the light-receiving region G1 through the division line 26 and the division line 26′, respectively.

Similarly, a square light-receiving area of the light-receiving element 25b is divided by a division line (a first division line) 28 that is substantially in parallel with the tangent to a track of the optical recording medium 15 and a division line (a second division line) 28′ that is substantially orthogonal to the division line 28. Thus, the light-receiving element 25b has four square light-receiving regions E2, F2, G2, and H2 disposed adjacent to each other in the form of a matrix. The light-receiving region E2 is disposed such that it adjoins the light-receiving region H2 and the light-receiving region F2 through the division line 28 and the division line 28′, respectively, and such that it is located diagonally to the light-receiving region G2. The light-receiving region G2 is disposed such that it adjoins the light-receiving region F2 and the light-receiving region H2 through the division line 28 and the division line 28′, respectively.

The light-receiving elements 23, 25a, and 25b are slightly offset from each other in the track direction of the medium to accommodate offsets of optical paths attributable to differences the positions of spots formed by the main beam 27 and the sub beams 29a and 29b of orders of ±1 on the information recording surface of the optical recording medium 15. The division lines 24, 26, and 28 are provided substantially in parallel with each other, and the division lines 24′, 26′, and 28′ are provided substantially in parallel with each other.

One wiring is extended from each of the light-receiving regions E1 to H1 and E2 to H2. The wirings are connected such that a light-receiving region of the light-receiving element 25a is connected to the light-receiving region of the light-receiving element 25b that is in the same relative position in the element 25b as the relative position of the region of the element 25a. Specifically, the wirings extended from the light-receiving regions E1 and E2 are connected to each other; the wirings extended from the light-receiving regions F1 and F2 are connected to each other; the wirings extended from the light-receiving regions G1 and G2 are connected to each other; and the wirings extended from the light-receiving regions H1 and H2 are connected to each other. Therefore, electrical signals output by the light-receiving regions E1 and E2 are at the same potential. Similarly, electrical signals output by the light-receiving regions F1, G1, and H1 are at the same potentials as electrical signals output by the light-receiving regions F2, G2, and H2, respectively. The wirings are connected to the error signal detection unit 31.

The wiring extended from each of the light-receiving regions A, B, C, and Disconnected to the error signal detection unit 31. The error signal detection unit 31 detects a focus error signal and a tracking error signal by performing predetermined arithmetic operations on the electrical signals output from the light-receiving regions A to D, E1 to H1, and E2 to H2.

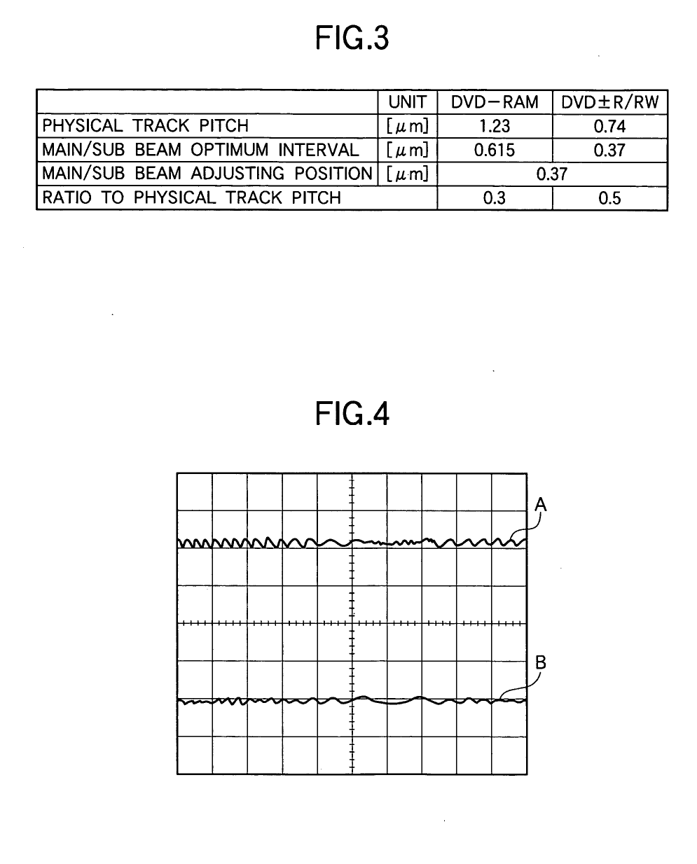

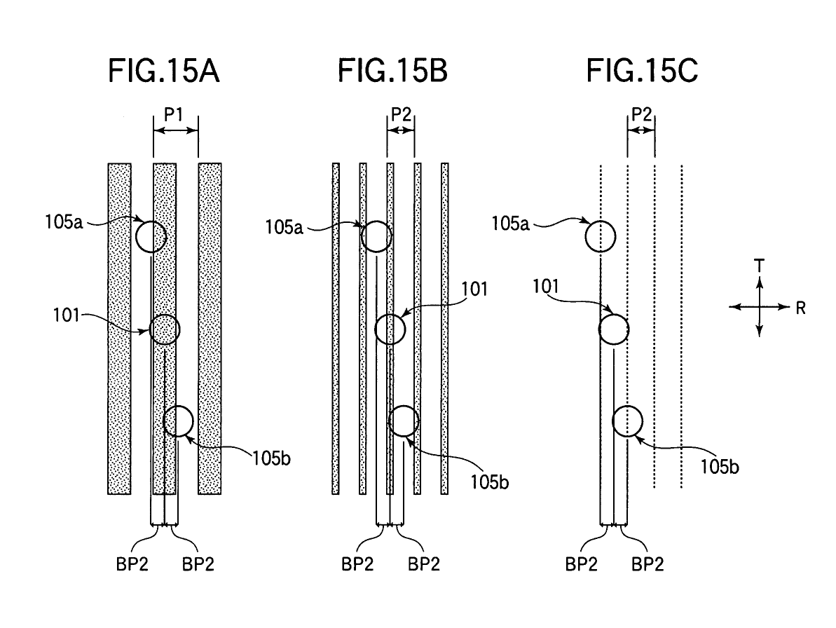

FIG. 3 shows a set value of the interval between spots of a main beam 27 and sub beams 29a and 29b of orders of ±1 from the optical head 1. As shown in FIG. 3, the spot interval between the main beam 27 and the sub beams 29a and 29b of orders of ±1 from the optical head 1 is set at 0.37 μm that is optimal for a DVD±R/RW. The spot interval between a main beam 27 and sub beams 29a and 29b of orders of ±1 converged on the information recording surface of the first or the second optical recording medium 15a or 15b is the same as the interval between the main beam 101 and the sub beams 103a and 103b of orders of ±1 shown in FIGS. 15A to 15C.

On the first optical recording medium 15a, since the spot interval is not 0.5 (=½) times the physical track pitch, a focus error signal can not be detected with track cross signals sufficiently eliminated even if the differential astigmatic focus error detection expressed by Expression 1 is used. Then, a description will now be made with reference to FIGS. 4 to 8 on the principles of detection of a focus error signal from which track cross signals have been sufficiently eliminated on the first optical recording medium 15a. A method of detecting a focus error signal of an optical head of the present embodiment is based on the fact that the phase of a track cross signal component included on a focus error signal detected using astigmatic focus error detection is the same as the phase of a push-pull signal detected using the push-pull method, i.e., the phase of track cross signal. The optical recording/reproducing apparatus 150 of the present embodiment is characterized in that a preferable focus error signal is obtained with track cross components eliminated by subtracting a signal obtained by multiplying an arithmetic signal according to the push-pull method (a second arithmetic signal) by an appropriate gain from an arithmetic signal according to astigmatic focus error detection (a first arithmetic signal).

FIG. 4 shows measured waveforms of tangential push-pull signals obtained using the tangential push-pull method from an optical recording medium on which focus servo is performed. FIG. 4 shows measured waveforms obtained by receiving a main beam and sub beams of orders of ±1 reflected by the information recording surface of the optical recording medium with light-receiving elements similar in configuration to the light-receiving elements 23, 25a, and 25b shown in FIG. 2 and photo-electrically converting the beams. The abscissa axis represents time, and the ordinate axis represents the amplitude of the tangential push-pull signals. The curve indicated by A in the figure represents a waveform of a tangential push-pull signal (MTPS) based on the main beam, and the curve indicated by B in the figure represents a waveform of a tangential push-pull signal (STPS) based on the sub beams of orders of ±1. The MTPS is obtained by receiving the main beam with the light-receiving element 23 and performing the following arithmetic process where electrical signals output by the light-receiving regions A, B, C, and D are represented by A, B, C, and D, respectively.
MTPS=(A+D)−(B+C) Expression 2

The STPS is obtained by receiving the sub beams of orders of ±1 with the light-receiving elements 25a and 25b and performing the following arithmetic process where electrical signals output by the light-receiving regions E1, F1, G1, G1, E2, F2, G2, and H2 are represented by E1, F1, G1, G1, E2, F2, G2, and H2, respectively.

$$\begin{matrix}STPS = ( E1 + E2 + H1 + H2 ) - ( F1 + F2 + G1 + G2 ) \\ = ( E + H ) - ( F + G )\end{matrix} \qquad Expression 3$$

As indicated by FIG. 2 and Expressions 2 and 3, the division lines 24′, 26′ and 28′ of the light-receiving elements 23, 25a, and 25b contributing to differential operations of the arithmetic processes performed to obtain tangential push-pull signals are substantially orthogonal to a tangent to a track of the optical recording medium. Therefore, substantially none of track cross signal components generated when the objective lens moves across a track will be superimposed on the MTPS and STPS.

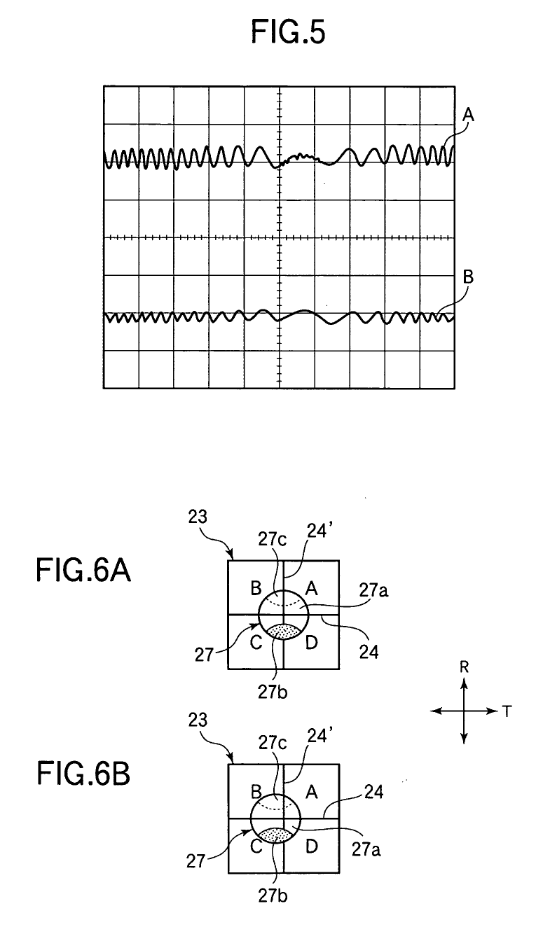

FIG. 5 shows measured waveforms of focus error signals obtained using astigmatic focus error detection while focus servo is working just as in FIG. 4. FIG. 5 shows measured waveforms obtained by receiving a main beam and sub beams of orders of ±1 reflected by the information recording surface of the optical recording medium with light-receiving elements similar in configuration to the light-receiving elements 23, 25a, and 25b shown in FIG. 2. The abscissa axis represents time, and the ordinate axis represents the amplitude of the focus error signals. The curve indicated by A in the figure represents a waveform of a focus error signal (MFES) based on the main beam, and the curve indicated by B in the figure represents a waveform of a focus error signal (SFES) based on the sub beams of orders of ±1. The MFES is obtained by receiving the main beam with the light-receiving element 23 and performing the following arithmetic process where electrical signals output by the light-receiving regions A, B, C, and D are represented by A, B, C, and D, respectively.
MFES=(A+C)−(B+D) Expression 4

The SFES is obtained by performing the following arithmetic process where electrical signals output by the light-receiving regions E1, F1, G1, G1, E2, F2, G2, and H2 are represented by E1, F1, G1, H1, E2, F2, G2, and H2, respectively.

$$\begin{matrix}SFES = ( E1 + E2 + G1 + G2 ) - ( F1 + F2 + H1 + H2 ) \\ = ( E + G ) - ( F + H )\end{matrix} \qquad Expression 5$$

As indicated by FIGS. 4 and 5, the amplitude of the MFES calculated using astigmatic focus error detection is greater than the amplitude of the MTPS calculated using the tangential push-pull method. Similarly, the amplitude of the SFES calculated using astigmatic focus error detection is greater than the amplitude of the STPS calculated using the tangential push-pull method. Thus, it will be understood that the track cross signals having a great amplitude are superimposed on focus error signals from both of the main and sub beams when astigmatic focus error detection is used.

According to astigmatic focus error detection, an electrical signal obtained by adding electrical signals output by one of the diagonal pairs of light-receiving regions of the light-receiving elements 23, 25a, and 25b having four divisions in the form of a matrix is subtracted from an electrical signal obtained by adding electrical signals output by the other pair of diagonal light-receiving regions. Therefore, an MFES or SFES should idealistically have a small number of track cross signals superimposed thereon like a tangential push-pull signal. In practice, however, the intensity of light beams converged on the light-receiving regions is asymmetric about the division lines 24′, 26′, and 28′ dividing the light-receiving areas of the light-receiving elements 23, 25a, and 25b in a direction substantially orthogonal to a tangent to a track of the optical recording medium, and the intensity is not equal between the regions. Therefore, track cross signals are superimposed on a focus error signal obtained using astigmatic focus error detection depending on the amounts of offsets of light beams converged on the light-receiving regions.

FIGS. 6A and 6B show examples of states of a main beam 27 converged on the light-receiving element 23. FIG. 6A shows a state in which the main beam 27 is converged substantially in the middle of the light-receiving element 23. FIG. 6B shows a state in which the main beam 27 is converged with an offset toward the light-receiving regions B and C of the light-receiving element 23. The horizontal arrow T in the figures represents a direction tangential to a track of the optical recording medium, and the vertical arrow R represents the radial direction of the optical recording medium. A plurality of lands and grooves alternately formed on an information recording surface of the optical recording medium serves as a diffraction grating. Thus, as shown in FIGS. 6A and 6B, the main beam 27 reflected by the optical recording medium and focused on the light-receiving surface of the light-receiving element 23 is diffracted, and the main beam 27 will therefore include a zero-order beam 27a, a beam 27b of order of ±1, and a beam 27c of order of −1. In FIGS. 6A and 6B, the sub beam 27b of order of ±1 which has a relatively high optical intensity is indicated by the solid line, and the beam 27c of order of −1 which has a relatively low intensity is indicated by the broken line.

The position of the main beam 27 converged on the light-receiving element 23 can shift as shown in FIGS. 6A and 6B because of non-uniformity of the intensity, e.g., aberration of the main beam 27 itself or because of foreign factors such as a positional shift that occurs when the optical path of the main beam 27 is adjusted. Each time the main beam 27 moves across a track of the optical recording medium 15, the intensity distribution of the main beam 27 converged on the light-receiving element 23 may become symmetrical or asymmetrical about the division line 24′. Further, each time the main beam 27 moves across a track of the optical recording medium 15, the intensity of the beam 27b of order of ±1 of the main beam 27 may be higher than the intensity of the beam 27c of order of −1. The intensity of the beam 27c of order of −1 may alternatively be higher than the intensity of the beam 27b of order of ±1. When the main beam 27 converged on the light-receiving element 23 has a positional shift each time the main beam 27 moves across a track of the optical recording medium 15, a resultant MFES or SFES will have great amplitude as shown in FIG. 5 where astigmatic focus error detection based on the calculations of Expressions 4 and 5 is employed. The MFES or the SFES is likely to include track cross signals when astigmatic focus error detection is used.

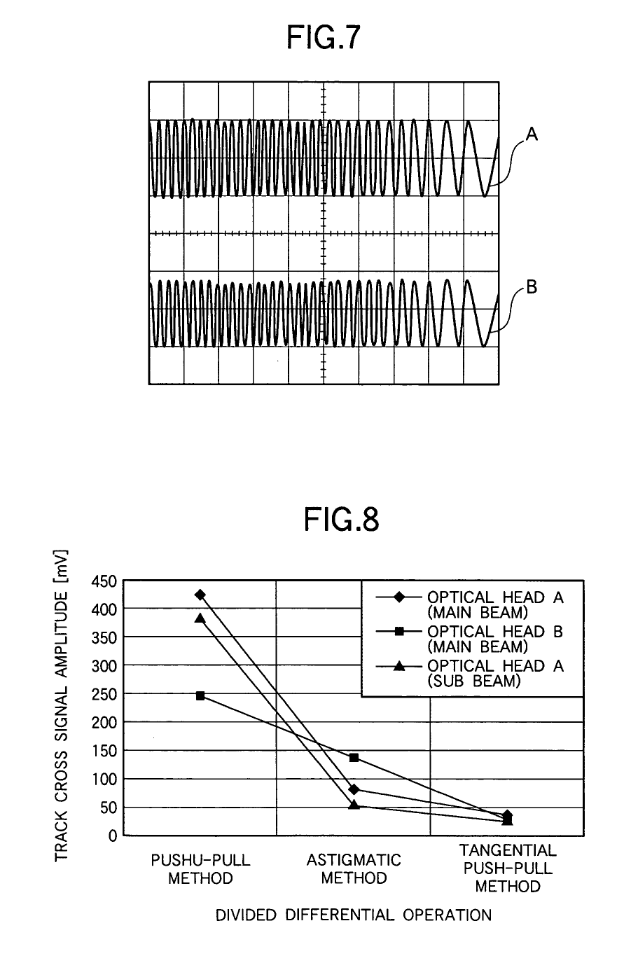

FIG. 7 shows measured waveforms of push-pull signals obtained using the push-pull method when focus servo is working just as in FIGS. 4 and 5. FIG. 7 shows measured wave forms obtained by receiving a main beam and sub beams of orders of ±1 reflected by the information recording surface of the optical recording medium with light-receiving elements similar in configuration to the light-receiving elements 23, 25a, and 25b shown in FIG. 2. The abscissa axis represents time, and the ordinate axis represents the amplitude of the push-pull signals. The curve indicated by A in the figure represents a waveform of a push-pull signal based on the main beam (MPS), and the curve indicated by B in the figure represents a waveform of a push-pull signal based on the sub beams of orders of ±1 (SPS). The MPS is obtained by receiving the main beam with the light-receiving element 23 and performing the following arithmetic process where electrical signals output by the light-receiving regions A, B, C, and D are represented by A, B, C, and D, respectively.
MPS=(A+B)−(C+D) Expression 6

The SPS is obtained by performing the following arithmetic process where electrical signals output by the light-receiving regions E1, F1, G1, H1, E2, F2, G2, and H2 are represented by E1, F1, GI, G1, E2, F2, G2, and H2, respectively.

$$\begin{matrix}SPS = ( E1 + E2 + F1 + F2 ) - ( G1 + G2 + H1 + H2 ) \\ = ( E + F ) - ( G + H )\end{matrix} \qquad Expression 7$$

A push-pull signal is used as a tracking error signal to effect tracking servo on an optical recording medium. According to the push-pull method, an error signal is detected from polarization of the intensity distribution of reflected light from an optical recording medium in a direction substantially orthogonal to a tangent to a track of the medium, i.e., in the radial direction of the medium. For example, as shown in FIGS. 6A and 6B, the intensity of the beams 27b and 27c of orders of ±1 of the main beam 27 changes each time the main beam 27 moves across a track of the optical recording medium 15. As a result, track cross signals included in a push-pull signal calculated using the push-pull method are greater in amplitude than those in signals obtained using the tangential push-pull method and astigmatic focus error detection.

Each optical head has a different amount of positional offset of the main beam 27 converged on the light-receiving element 23 shown in FIGS. 6A and 6B. Because of differences between individual optical heads, the amount of track cross signal components superimposed on an MFES or SFES obtained using astigmatic focus error detection varies for each optical head.

FIG. 8 shows results of measurement carried out on two types of optical heads A and B manufactured in the same design to see maximum values of the amplitude of track cross signal components included in arithmetic signals obtained by various methods of calculation. The abscissa axis represents directions of differential calculations between divisions of a light-receiving area, and the ordinate axis represents maximum values (mV) of the amplitude of track cross signal components. The differential calculations in Expressions 6 and 7 are used as calculations in the push-pull direction. The differential calculations in Expressions 4 and 5 are used as calculations in the astigmatic detection. The differential calculations in Expressions 2 and 3 are used as calculations in the tangential push-pull direction. The solid diamond-like symbols in the figure represent amplitudes of track cross signals based on a main beam from the optical head A. The solid square symbols in the figure represent amplitudes of track cross signals based on a main beam B from the optical head B. The solid triangular symbols in the figure represent amplitudes of track cross signals based on sub beams from the optical head A.

As shown in FIG. 8, the ratio of the amplitude of track cross signals calculated in the push-pull direction to the amplitude of track cross signals calculated in the astigmatic direction is different between the optical heads A and B. The ratio of the amplitude of track cross signals obtained by the calculations in the astigmatic direction (astigmatic focus error detection) to the amplitude of track cross signals obtained by the calculations in the push-pull direction (push-pull method) is about 1:5 for the optical head A and about 7:12 for the optical head B. Therefore, the ratio of track cross signal components included in an astigmatic signal to those included in a push-pull signal is ⅕=0.2 for the optical head A and 7/12=0.58 for the optical head B. Thus, the amplitude of track cross signal components in an astigmatic signal is significantly different between the optical head A and B in the same design.

The optical recording/reproducing apparatus 150 of the present embodiment performs a differential operation between an MFES obtained by astigmatic focus error detection as expressed by Expression 4 and an MPS obtained by the push-pull method as expressed by Expression 6 to detect a focus error signal in which track cross signal components have been attenuated. However, as shown in FIG. 8, the amplitude of track cross signals included in an MFES obtained by astigmatic focus error detection is different from the amplitude of track cross signals included in an MPS obtained by the push-pull method. Under the circumstance, a differential operation between an MPS and an MFES may be performed after amplifying the MPS by a predetermined amount, which allows track cross signal components included in the MFES to be sufficiently attenuated. A focus error signal can be obtained with track cross signal components attenuated using the following arithmetic expression.
FES={(A+C)−(B+D)}−k1×((A+B)−(C+D)} Expression 8

An optimum value of the coefficient k1 will now be described. As indicated by Expression 8, a focus error signal is generated by performing an arithmetic process only on electrical signals obtained by receiving a main beam. Therefore, the ratio of track cross signal components included in an astigmatic signal to those in a push-pull signal as described with reference to FIG. 8 may be directly used as the coefficient k1 by which the push-pull signal to be subtracted is multiplied. The coefficient k1 is therefore 0.2 and 0.58 for the optical heads A and B, respectively.

As thus described, in the case of the optical recording/reproducing apparatus 150 of the present embodiment, the value of the coefficient k1 used for calculating a focus error signal is 1 or less which is small compared to a coefficient k=8 used in differential astigmatic focus error detection according to the related art. Since the gain (amplification factor) of the amplification circuit of the optical recording/reproducing apparatus 150 can therefore be kept small, it is possible to prevent degradation of the S/N ratio of a focus error signal, saturation of a peak value of an electrical signal output by the amplification circuit, and the like.

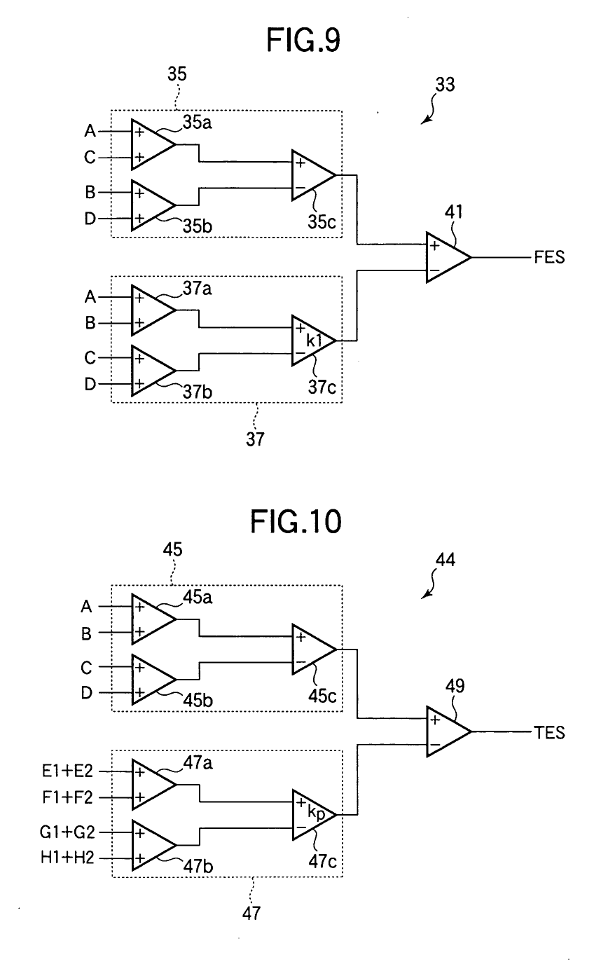

A description will now be made with reference to FIG. 9 on a configuration of an FES detecting portion which can perform the calculation of Expression 8. FIG. 9 shows an example of a circuit configuration of an FES detecting portion 33 provided in the error signal detection unit 31 of the optical precording/reproducing apparatus 150. As shown in FIG. 9, the FES detecting portion 33 has an MFES generating part 35 which performs a differential operation between electrical signals output by the light-receiving element 23 to generate an MFES (a first arithmetic signal) as expressed by Expression 4, an MPS generating part 37 which performs a differential operation between electrical signals output by the light-receiving element 23 to generate an MPS (a second arithmetic signal) as expressed by Expression 6, and an FES generating part 41 which performs a differential operation between the MFES output by the MFES generating part 35 and the MPS output by the MPS generating part 37 to generate a focus error signal.

The MFES generating part 35 includes adders 35a and 35b and a differential part 35c. The adders 35a and 35b and the differential part 35c have a circuit configuration with two inputs and one output. One of the input terminals (+) of the adder 35a is connected to the light-receiving region A, and the other input terminal (+) is connected to the light-receiving region C. The output terminal of the adder 35a is connected to a non-inverting input terminal (+) of the differential part 35c. One of the input terminals (+) of the adder 35b is connected to the light-receiving region B, and the other input terminal (+) is connected to the light-receiving region D. The output terminal of the adder 35b is connected to an inverting input terminal (−) of the differential part 35c. An output terminal of the differential part 35c (an output terminal of the MFES generating part 35) is connected to a non-inverting input terminal (+) of the FES generating part 41.

The MFES generating part 35 performs a differential operation between an electrical signal output by one of the diagonal pairs of light-receiving regions of the light-receiving element 23, i.e., the regions A and C and an electrical signal output by the other diagonal pair of light-receiving regions, i.e., the regions B and D to output an MFES as shown in Expression 4.

The MPS generating part 37 includes adders 37a and 37b and a differential amplifier 37c. The adders 37a and 37b and the differential amplifier 37c have a circuit configuration with two inputs and one output. One of the input terminals (+) of the adder 37a is connected to the light-receiving region A, and the other input terminal (+) is connected to the light-receiving region B. The output terminal of the adder 37a is connected to a non-inverting input terminal (+) of the differential amplifier 37c. One of the input terminals (+) of the adder 37b is connected to the light-receiving region C, and the other input terminal (+) is connected to the light-receiving region D. The output terminal of the adder 37b is connected to an inverting input terminal (−) of the differential amplifier 37c. The output terminal of the differential amplifier 37c (an output terminal of the MPS generating part 37) is connected to an inverting input terminal (−) of the FES generating part 41.

The differential amplifier 37c has a function of performing a differential operation between an addition signal A+B output by the adder 37a and an addition signal C+D output by the adder 37b and amplifying the result by a factor of k1. The amplification factor (coefficient k1) is set separately for each optical head 1 and each of the first and the second recording media 15a and 15b based on the ratio of track cross signal components included in each of MFES and MPS.

The MPS generating part 37 performs a differential operation between an electrical signal output from one side of the light-receiving element 23 divided by the division line 24, i.e., the light-receiving regions A and B and an electrical signal output from the other side, i.e., the light-receiving regions C and D to output a signal which is an MPS as shown in Expression 6 while amplifying the voltage of the signal by the factor of k1.

The FES generating part 41 performs a differential operation between the MFES and the MPS whose voltage has been amplified by the factor of k1 to generate a focus error signal. The amplification factor (coefficient k1) of the differential amplifier 37c of the MPS generating part 37 is set at an optimum value for each optical head 1 and for each of the first and second optical recording media 15a and 15b such that track cross signal components can be attenuated. As a result, the optical head 1 of the present embodiment is capable of detecting a focus error signal in which track cross signals have been attenuated from either of the first and the second optical recording media 15a and 15b.

A configuration of a TES detecting portion will now be described with reference to FIG. 10. FIG. 10 shows an example of a circuit configuration of a TES detecting portion 44 provided in the error signal detection unit 31. The optical recording/reproduction apparatus 150 of the present embodiment detects a tracking error signal using the differential push-pull method from either of the first and the second optical recording media 15a and 15b. As shown in FIG. 10, the TES detecting portion 44 has an MPS generating part 45 which performs a differential operation between electrical signals output by the light-receiving element 23 to generate an MPS as expressed by Expression 6, an SPS generating part 47 which performs a differential operation between electrical signals output by the light-receiving elements 25a and 25b to generate an SPS as expressed by Expression 7, and a TES generating part 49 which generates a tracking error signal by subtracting an SPS from an MPS.

The MPS generating part 45 includes adders 45a and 45b and a differential part 45c. The adders 45a and 45b and the differential part 45c have a circuit configuration with two inputs and one output. One of the input terminals (+) of the adder 45a is connected to the light-receiving region A, and the other input terminal (+) is connected to the light-receiving region B. The output terminal of the adder 45a is connected to a non-inverting input terminal (+) of the differential part 45c. One of the input terminals (+) of the adder 45b is connected to the light-receiving region C, and the other input terminal (+) is connected to the light-receiving region D. The output terminal of the adder 45b is connected to an inverting input terminal (−) of the differential part 45c. The output terminal of the differential part 45c (an output terminal of the MPS generating part 45) is connected to a non-inverting input terminal (+) of the TES generating part 49.

The MPS generating part 45 performs a differential operation between an electrical signal output from one side of the light-receiving element 23 divided by the division line 24, i.e., the regions A and B and an electrical signal output from the other side, i.e., the regions C and D to output an MPS as shown in Expression 6.

The SPS generating part 47 includes adders 47a and 47b and a differential amplifier 47c. The adders 47a and 47b and the differential amplifier 47c have a circuit configuration with two inputs and one output. One of the input terminals (+) of the adder 47a is connected to a wiring E1+E2 connecting the light-receiving regions E1 and E2 The other input terminal (+) of the adder 47a is connected to a wiring F1+F2 connecting the light-receiving regions F1 and F2. The output terminal of the adder 47a is connected to a non-inverting input terminal (+) of the differential amplifier 47c. One of the input terminals (+) of the adder 47b is connected to a wiring G1+G2 connecting the light-receiving regions G1 and G2. The other input terminal (+) of the adder 47b is connected to a wiring H1+H2 connecting the light-receiving regions H1 and H2. The output terminal of the adder 47b is connected to an inverting input terminal (-) of the differential amplifier 47c. The output terminal of the differential amplifier 47c (an output terminal of the SPS generating part 47) is connected to an inverting input terminal (−) of the TES generating part 49.

The differential amplifier 47c has a function of performing a differential operation between an addition signal E+F output by the adder 47a and an addition signal G+H output by the adder 47b and amplifying the result by a factor of kp. The amplification factor (coefficient kp) of the differential amplifier 47c is set separately for each optical head 1 and each of the first and the second optical recording media 15a and 15b such that DC offset components generated by shifts of the objective lens in the radial direction of the medium can be satisfactorily eliminated from a tracking error signal.

The TES generating part 49 generates a tracking error signal by subtracting the SPS which is output by the SPS generating part 47 and whose voltage has been amplified by the factor of kp from the MPS output by the MPS generating part 45. Therefore, a tracking error signal output by the TES generating part 49 can be expressed as follows.
TES={(A+B)−(C+D)}−kp×{(E+F)−(G+H)} Expression 9

The interval between the spots of the main beam 27 and the sub beams 29a and 29b of orders of ±1 from the optical head 1 of the present embodiment is set at the optimum value for the second optical recording medium 15b (DVD±R/RW). Therefore, the amplitude of a track cross signal included in sub beams 29a and 29b of orders of ±1 reflected by the second optical recording medium 15b is at the maximum (see FIG. 17). A track cross signal from the first optical recording medium 15a (DVD-RAM) will not be at the maximum amplitude when the spot interval is set as described above. However, as shown in FIG. 7, the amplitude of a track cross signal obtained using the push-pull method is greater than the amplitude of track cross signals obtained using other methods of calculation. Further, the absolute value of the amplitude of a track cross signal included in sub beams 29a and 29b of orders of ±1 from the first optical recording medium 15a is greater than the absolute value of a track cross signal included in sub beams 29a and 29b of orders of ±1 from the second optical recording medium 15b. In the case of the first optical recording medium 15a, it is therefore possible to satisfactorily eliminate DC offset components generated by shifts of the objective lens in the radial direction of the medium from a tracking error signal with the amplification factor (coefficient kp) of the SPS generating part 47 set at a not so high value. Therefore, the optical recording/reproducing apparatus 150 is capable of detecting a tracking error signal from which DC offset components have been eliminated from either of the first and the second optical recording media 15a and 15b.

Operations of the optical head 1 and the error signal detection unit 31 will now be described with reference to FIG. 1. As shown in FIG. 1, a divergent light beam emitted by a laser diode 3 enters the diffraction grating 19. The light beam is split by the diffraction grating 19 into a main beam 27 of order of 0 and sub beams 29a and 29b of orders of ±1. The divergent main beam 27 and sub beams 29a and 29b of orders of ±1 which have exited the diffraction grating 19 enter the polarization beam splitter 5. Linearly polarized components at a predetermined polarization direction of the main beam 27 and the sub beams 29a and 29b of orders of ±1 are transmitted by the polarization beam splitter 5 to enter the quarter-wave plate 7. On the contrary, linearly polarized components orthogonal to the polarization direction are reflected to enter the power monitoring photodiode 11 which measures the intensity of the light beam.

The linearly polarized main beam 27 and sub beams 29a and 29b of orders of ±1 which have entered the quarter-wave plate 7 are converted into circularly polarized main beam 27 and first-order sub beams 29a and 29b of orders of ±1 by transmitting the quarter-wave plate 7. The circularly polarized main beam 27 and sub beams 29a and 29b of orders of ±1 are converted by the collimator lens 9 into parallel beams which are converged by the objective lens 13 after passing through the collimator lens 9 and are converged and reflected on the information recording surface of the optical recording medium 15. At this time, the spot intervals between the main beam 27 and the sub beams 29a and 29b of orders of ±1 in the radial direction of the medium are about 0.37 μm, and the spot interval between the sub -beams 29a and 29b of orders of ±1 in the radial direction is 0.74 μm. The circularly polarized main beam 27 and sub beams 29a and 29b of orders of ±1 reflected on the information recording surface of the optical recording medium 15 are converted by the objective lens 13 into parallel beams which are then transmitted by the collimator lens 9 to enter the quarter-wave plate 7. When transmitted by the quarter-wave plate 7, the circularly polarized main beam 27 and sub beams 29a and 29b of orders of ±1 are converted into linearly polarized beams whose polarizing direction is at a rotation of 90° from that of the initial linearly polarized beams, and the linearly polarized beams enter the polarization beam splitter 5. The linearly polarized main beam 27 and sub beams 29a and 29b of orders of ±1 are reflected by the polarization beam splitter 5 to enter the sensor lens 17.

The cylindrical lens 21 imparts astigmatism to the main beam 27 and sub beams 29a and 29b of orders of ±1 after the beams are transmitted by the sensor lens 17, and the beams are then converged on the light-receiving elements 23, 25a, and 25b, respectively. The main beam 27 and sub beams 29a and 29b of orders of ±1 received by the light-receiving elements 23, 25a, and 25b, respectively, are converted into electrical signals which are input to the error signal detection unit 31. Based on the electrical signals output by the light-receiving elements 23, 25a, and 25b, the error signal detection unit 31 detects a focus error signal in which track cross signals have been attenuated and a tracking error signal from which DC offset components have been eliminated regardless of the type of the medium, i.e., the first or the second optical recording medium 15a or 15b.

A method of detecting a focus error signal used in the optical head of the present embodiment will be described. First, when the first or the second optical recording medium 15a or 15b is placed in the optical recording/reproducing apparatus 150, an MFES, MPS, and SPS are detected with predetermined focus servo performed on the first or the second optical recording medium 15a or 15b and optimum values of the coefficients k1 and kp are calculated. When the self test for calculating optimum values of the coefficients k1 and kp is completed, as seen in the above description of the operation of the optical head 1, a light beam emitted by the laser diode 3 is made to enter the diffraction grating 19 to diffract and split the light beam into a main beam 27 and sub beams 29a and 29b of orders of ±1. Next, the sub beams 29a and 29b of orders of ±1 which have been converged on the information recording surface of the optical recording medium 15 through the objective lens 13 are adjusted such that they will be symmetrical about the spot of the main beam 27 and will be in positions at 0.37 μm from the main beam in the radial direction of the medium. The spot interval between the main beam 27 and the sub beams 29a and 29b of orders of ±1 is adjusted by rotating the grating surface of the diffraction grating 19 about the optical axis of the diffraction grating 19.

Then, the main beam 27 and sub beams 29a and 29b of orders of ±1 reflected by the optical recording medium 15 are converged on the light-receiving elements 23, 25a, and 25b, respectively. By receiving the main beam 27 and sub beams 29a and 29b of orders of ±1 on the light-receiving elements 23, 25a, and 25b, an electrical signal obtained by photoelectric conversion at the light-receiving element 23 is input to the error signal detection unit 31. A light-receiving region of the light-receiving element 25a is connected to a light-receiving region of the element 25b in the same position relative to the other regions in the light receiving area. Therefore, a pair of electrical signals at the same electrical potential is input to the error signal detection unit 31 from each of the pairs of the light-receiving regions E1 and E2, the light-receiving regions F1 and F2, the light-receiving regions G1 and G2, and the light-receiving regions H1 and H2.

As a result of the above-described self test, the amplification factor (coefficient k1) of the MPS generating part 37 and the amplification factor (coefficient kp) of the SPS generating part 47 are set at optimum values for each of the first and the second optical recording media 15a and 15b. Thus, the error signal detection unit 31 detects a focus error signal in which track cross signals have been attenuated and a tracking error signal from which DC offset components have been eliminated based on the electrical signals output by the light-receiving elements 23, 25a, and 25b regardless of the type of the medium, i.e., the first or the second optical recording medium 15a or 15b.

As described above, in the optical recording/reproducing apparatus 150 of the present embodiment, the ratio of track cross signal components included in each of a push-pull signal and an astigmatic signal is obtained, and the amplification factor (coefficient k1) of the MPS generating part 37 is set based on the inclusion ratio, which allows the value of the amplification factor (coefficient k1) to be kept small. As a result, the optical recording/reproducing apparatus 150 can detect a focus error signal in which track cross signals have been attenuated even when the spot interval between the main beam 27 and the sub beams 29a and 29b of orders of ±1 is not in an optimum state or shifted from the optimum state.

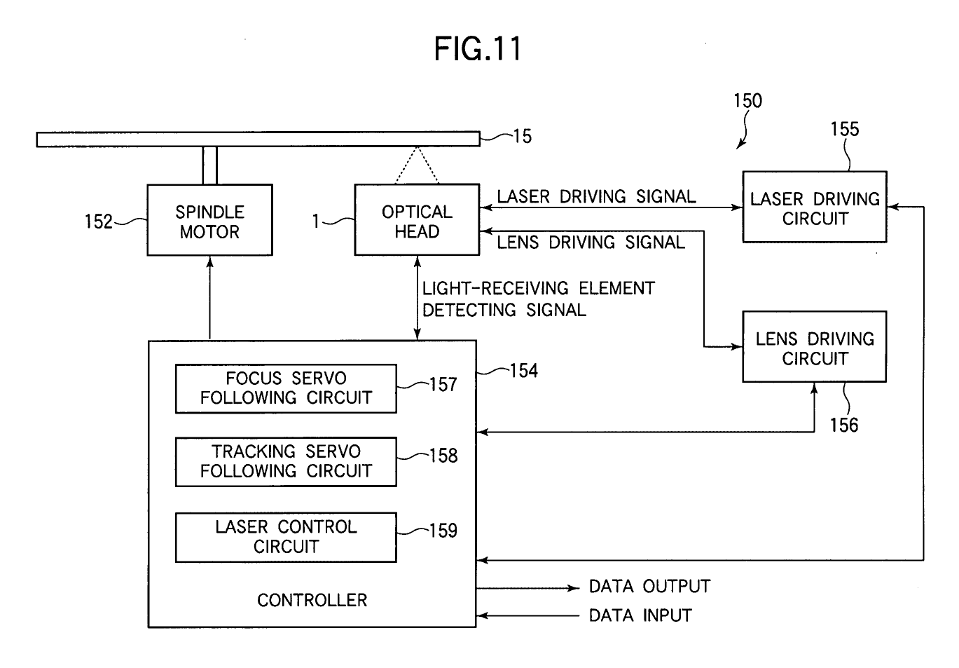

The optical recording/reproducing apparatus of the present embodiment will now be described. FIG. 11 shows a schematic configuration of the optical recording/reproducing apparatus 150 loaded with the optical head 1 of the present embodiment. As shown in FIG. 11, the optical recording/reproducing apparatus 150 includes a spindle motor 152 for rotating an optical recording medium 15, an optical head 1 for irradiating the optical recording medium 15 with a laser beam and for receiving light reflected by the same, a controller 154 for controlling the operation of the spindle motor 152 and the optical head 1, a laser driving circuit 155 for supplying a laser driving signal to the optical head 1, and a lens driving circuit 156 for supplying a lens driving signal to the optical head 1.

The controller 154 includes a focus servo following circuit 157, a tracking servo following circuit 158, and a laser control circuit 159. The error signal detection unit 31 is provided across the focus servo following circuit 157 and the tracking servo following circuit 158. When the focus servo following circuit 157 operates, the information recording surface of the rotating optical recording medium 15 is focused. When the tracking servo following circuit 158 operates, a laser beam spot automatically follows up any eccentric signal track of the optical recording medium 15. The focus servo following circuit 157 and the tracking servo following circuit 158 are provided with an automatic gain control function for automatically adjusting a focus gain and a tracking gain, respectively. The laser control circuit 159 is a circuit for generating a laser driving signal to be supplied by the laser driving circuit 155, and the circuit generates an adequate laser driving signal based on recording condition setting information that is recorded in the optical recording medium 15.

It is not essential that the focus servo following circuit 157, the tracking servo following circuit 158, and the laser control circuit 159 are circuits incorporated in the controller 154, and the circuits may be components separate from the controller 154. Further, it is not essential that those elements are physical circuit, and they may be programs executed in the controller 154.

In a system operation of the optical recording/reproducing apparatus 150, optimum values of the coefficients k1 and kp are calculated through a self test for each of the first and the second optical recording media 15a and 15b on which recording and reproduction is to be performed.. It is therefore possible to eliminate track cross components included in a focus error signal efficiently and to eliminate DC offset components superimposed on a tracking error signal.

### Second Embodiment

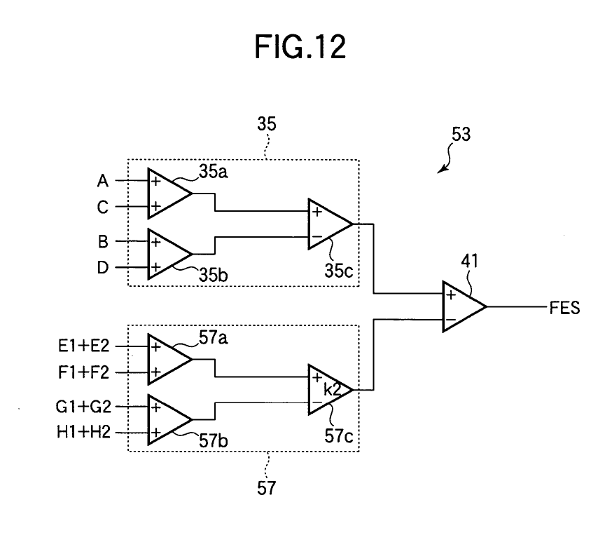

A description will now be made with reference to FIG. 12 on a method of detecting a focus error signal of an optical head and an optical head and an optical recording/reproducing apparatus utilizing the same according to a second embodiment of the invention. The schematic configurations of an optical head 1 and an optical recording/reproducing apparatus 150 of the present embodiment will not be described because they are schematically the same as those of the optical head 1 and the optical recording/reproducing apparatus 150 of the first embodiment. The interval between the spots of a main beam 27 and sub beams 29a and 29b of orders of ±1 from the optical head 1 of the present embodiment is set at 0.39 μm that is an optimum value for the second optical recording medium 15b just as for the optical head 1 of the first embodiment.

The optical recording/reproducing apparatus 150 of the present embodiment is characterized in that it detects a focus error signal in which track cross signal components have been attenuated by subtracting an SPS amplified by a predetermined amount from an MFES instead of an MPS. In the optical recording/reproducing apparatus of the present embodiment, a focus error signal is calculated according to the following arithmetic expression.
FES={(A+C)−(B+D)}−k2×{(E+F)−(G+H)} Expression 10

Referring to FIG. 7, an MPS represented by the curve A is in phase with an SPS represented by the curve B, although they are slightly different in amplitude. Therefore, just as in the first embodiment in which the optical recording/reproducing apparatus 150 cancels track cross signal components using an MFES and MPS, track cross signals can be cancelled using an MFES and SPS by setting the coefficient k2 shown in Expression 10 at an optimum value to detect a focus error signal in which the track cross signals have been attenuated.

An optimum value of the coefficient k2 will now be described. The value of the coefficient k2 must be set such that Expression 10 will read FES=0. Referring to FIG. 8, track cross signal components included in push-pull signals from a main beam and sub beams have values that are substantially the same in the case of the optical head A. Therefore, it can be assumed that the ratio of track cross signal components included in each of a push-pull signal and an astigmatic signal is 0.2 in the case of the optical head A and 0.58 in the case of the optical head B. Let us assume now that the ratio of the optical energy of the main beam to that of the sub beams is 18:1 and that the ratio of the photoelectrical conversion gain of a light-receiving element for receiving the main beam to the photoelectrical conversion gain of light-receiving elements for receiving the sub beams is 1:3.74 just as in the first embodiment. Then, an optimum value of the coefficient k2 can be calculated as (18×1)÷(2×1×3.74)×0.2=0.48 for the optical head A. An optimum value of the coefficient k2 can be calculated as (18×1)÷(2×1×3.74)×0.58=1.4 for the optical head B.

It is not necessary to set the coefficient k2 at a great value also in a method for detecting a focus error signal by performing a differential operation between an MFES and an SPS. The optical recording/reproducing apparatus 150 can therefore provide the same advantages as those of the optical recording apparatus 150 of the first embodiment.

A description will now be made on a configuration of an FES detecting portion which can perform the calculation of Expression 10. FIG. 12 shows an example of a circuit configuration of an FES detecting portion 53 provided in an error signal detection unit 31 of the optical recording/reproducing apparatus 150 in the present embodiment. The FES detecting portion 53 is characterized in that it has an SPS generating part 57 instead of the MPS generating part 37 of the FES detecting portion 33 of the optical recording/reproducing apparatus 150 in the first embodiment. Elements of the FES detecting portion 53 having effects and functions as those of the elements of the FES detecting portion 33 shown in FIG. 9 will be indicated by like reference numerals and will not be described.

The SPS generating part 57 includes adders 57a and 57b and a differential amplifier 57c. The adders 57a and 57b and the differential amplifier 57c have a circuit configuration with two inputs and one output. One of the input terminals (+) of the adder 57a is connected to a wiring E1+E2 connecting the light-receiving regions E1 and E2. The other input terminal (+) of the adder 57a is connected to a wiring F1+F2 connecting the light-receiving regions F1 and F2. The output terminal of the adder 57a is connected to a non-inverting input terminal (+) of the differential amplifier 57c. One of the input terminals (+) of the adder 57b is connected to a wiring G1+G2 connecting the light-receiving regions G1 and G2. The other input terminal (+) of the adder 57b is connected to a wiring H1+H2 connecting the light-receiving regions G1 and H2. The output terminal of the adder 57b is connected to an inverting input terminal (−) of the differential amplifier 57c. The output terminal of the differential amplifier 57c (an output terminal of the SPS generating part 57) is connected to an inverting input terminal (−) of an FES generating part 41.

The differential amplifier 57c has a function of performing a differential operation between an addition signal E+F output by the adder 57a and an addition signal G+H output by the adder 57b and amplifying the result by a factor of k2. The amplification factor (coefficient k2) is set separately for each optical head 1 and each of the first and the second recording media 15a and 15b based on the ratio of track cross signal components included in each of an MFES and an SPS.

The SPS generating part 57 performs a differential operation between an addition signal obtained by adding an electrical signal output from one side of the light-receiving element 25a divided by the division line 26, i.e., the light-receiving regions E1 and F1 and an electrical sign a output from one side of the light-receiving element 25b divided by the division line 28, i.e., the light-receiving regions E2 and F2 and an addition signal obtained by adding an electrical signal output from the other side of the light-receiving element 25a, i.e., the light-receiving regions G1 and H1 and an electrical signal output from the other side of the light-receiving element 25b, i.e., the light-receiving regions G2 and H2 to output a signal which is an SPS as shown in Expression 7 while amplifying the voltage of the signal by the factor of k2.

The FES generating part 41 performs a differential operation between the MFES and the SPS whose voltage has been amplified by the factor of k2 to generate a focus error signal. The amplification factor (coefficient k2) of the differential amplifier 57c of the SPS generating part 57 is set at an optimum value for each of the first and the second optical recording media such that track cross signal components included in the FES can be attenuated. As a result, the optical recording/reproducing apparatus 150 of the present embodiment is capable of detecting a focus error signal in which track cross signals have been attenuated from either of the first and the second optical recording media 15a and 15b.

A TES detecting portion of the optical recording/reproducing apparatus 150 of the present embodiment will not be described because it is similar in configuration to the TES detecting portion 44 of the optical recording/reproducing apparatus 150 of the first embodiment. The operation of the optical head 1 and the method of detecting a focus error signal used in the optical head 1 of the present embodiment will not be described because they are similar to those of the optical head 1 of the first embodiment.

As described above, in the optical recording/reproducing apparatus 150 having the optical head 1 and the error signal detection unit 31 of the present embodiment, the amplification factor (k2) of the SPS generating portion 57 can be set using the ratio of track cross signal components included in each of a push-pull signal based on the sub beams 29a and 29b of orders of ±1 and an astigmatic signal based on the main beam 27. Thus, the value of the amplification factor (k2) can be small. As a result, the optical head 1 can detect a focus error signal in which track cross signals have been attenuated even when the interval between the spots of the main beam 27 and the sub beams 29a and 29b of orders of ±1 is not in an optimum state or shifted from the optimum state.

### Third Embodiment

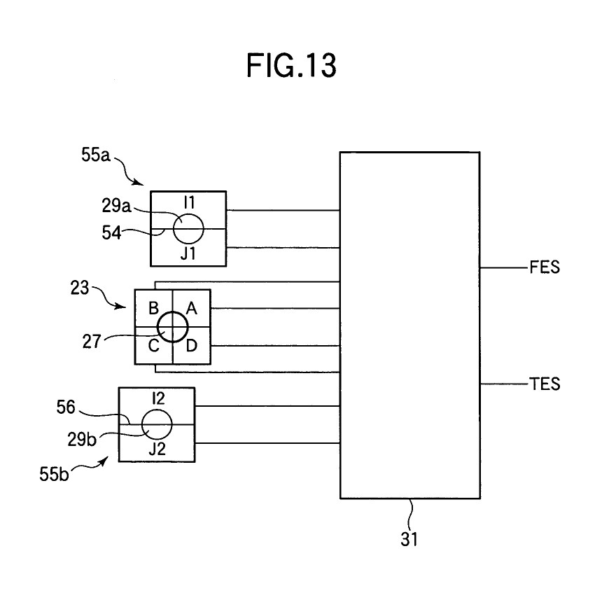

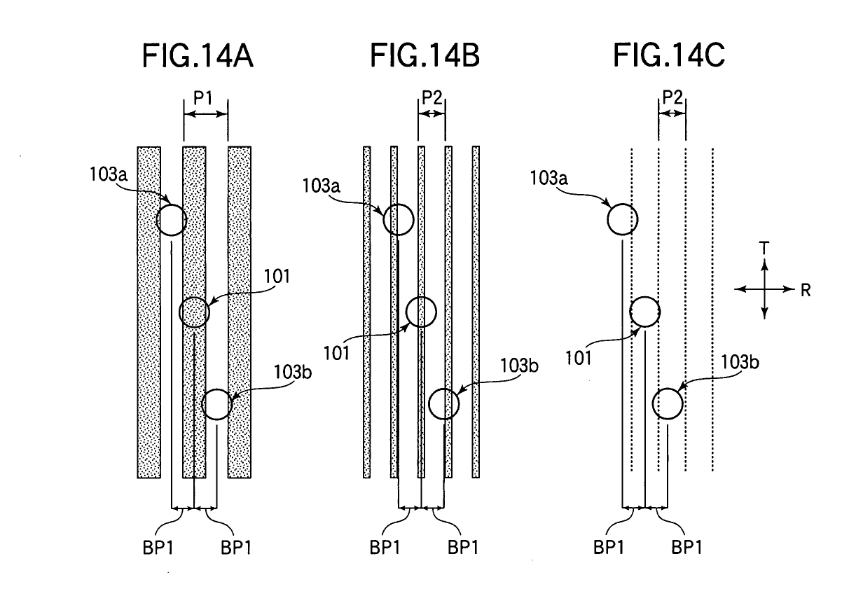

A description will now be made with reference to FIG. 13 on a method of detecting a focus error signal of an optical head and an optical head and an optical recording/reproducing apparatus utilizing the same according to a third embodiment of the invention. The schematic configurations of an optical head 1 and an optical recording/reproducing apparatus 150 of the present embodiment will not be described because they are schematically the same as those of the optical head 1 and the optical recording/reproducing apparatus 150 of the first embodiment. The interval between the spots of a main beam 27 and sub beams 29a and 29b of orders of ±1 from the optical head 1 of the present embodiment is set at 0.39 μm that is an optimum value for the second optical recording medium 15b just as for the optical head 1 of the first and the second embodiments.

The optical head 1 provided in the optical recording/reproducing apparatus 150 of the present embodiment is characterized in that light-receiving areas of light-receiving elements for receiving the sub beams 29a and 29b of orders of ±1 are divided into two regions by a division line that is substantially in parallel with a tangent to a track of the optical recording medium 15. FIG. 13 shows a configuration of light-receiving portions of light-receiving elements 23, 55a, and 55b and connections between the light-receiving elements 23, 55a, and 55b and an error signal detection unit 31. As shown in FIG. 13, a square light-receiving area of the light-receiving element 55a for receiving the sub beam 29a of order of ±1 is divided by a division line (a first division line) 54 that is substantially in parallel with a tangent to a track of the optical recording medium 15 to provide two rectangular light-receiving regions I1 and J1 disposed adjacent to each other. Similarly, a square light-receiving area of the light-receiving element 55b for receiving the sub beam 29b of order of −1 is divided by a division line (a first division line) 56 that is substantially in parallel with the tangent to a track of the optical recording medium 15 to provide two rectangular light-receiving regions I2 and J2 disposed adjacent to each other. The light receiving elements 55a and 55b are connected to the error signal detection unit 31 by a wiring extended from each of the light-receiving regions I1, I2, J1, and J2.

The optical recording/reproducing apparatus 150 of the present embodiment detects a focus error signal by subtracting an SPS amplified by a predetermined amount from an MFES just like the optical recording/reproducing apparatus 150 of the second embodiment. Therefore, in the optical head 1 of the present embodiment, a focus error signal is calculated according to the following arithmetic expression.
FES=}(A+C)−(B+D)}−k3×{(I1+I2)−(J1+J2)} Expression 11

The FES detecting portion 53 of the error signal detection unit 31 of the second embodiment may be used as an FES detecting portion of the error signal detection unit 31 of the present embodiment. For example, an electrical signal output by the light-receiving region I1 is input to one of the input terminals (+) of the adder 57a shown in FIG. 12, and an electrical signal output by the light-receiving element I2 is input to the other input terminal (+). Thus, the adder 57a can output an addition signal I1+I2 obtained by adding the electrical signals output by the light-receiving regions I1 and I2. Similarly, an electrical signal output by the light-receiving region J1 is input to one of the input terminals (+) of the adder 57b, and an electrical signal output by the light-receiving element J2 is input to the other input terminal (+). Thus, the adder 57b can output an addition signal J1+J2 obtained by adding the electrical signals output by the light-receiving regions J1 and J2. The addition signals I1+I2 and J1+J2 are subjected to a differential operation at the differential operation part 57c, and the voltages of the signals are amplified by a factor of k3 when the amplification factor of the differential operation part 57c is set at the coefficient k3.

The amplification factor (coefficient k3) of the differential operation part 57c equals the coefficient k2 when the ratio of the optical energy of the main beam to that of the sub beams and the ratio of the photoelectrical conversion gain of the light-receiving element for receiving the main beam to that of the light receiving-elements for receiving the sub beams are the same as those in the second embodiment.

As thus described, the SPS generating part 57 shown in FIG. 12 can perform the arithmetic process represented by the second term of Expression 11. The FES detecting portion 53 can detect a focus error signal in which track cross signals have been attenuated even from the light-receiving elements 55a and 55b divided into two light-receiving regions I1 and J1 and I2 and J2, respectively as shown in FIG. 13.

Tolerance for shifts in positional adjustment of the sub beams 29a and 29b of orders of ±1 will increase when light-receiving areas are divided into two respective pairs of light-receiving regions, i.e., the pair of regions I1 and J1 and the pair of regions I2 and J2 just as in the light-receiving elements used in the differential push-pull method according to the related art as shown in FIG. 13 instead of forming matrices of four divisional light-receiving regions like the groups of the regions E1 to H1 and E2 to H2 of the respective light -receiving elements 25a and 25b shown in FIG. 2. It is therefore possible to reduce the load of optical axis adjustment for the optical system of the optical head 1 that is one of steps of manufacturing the optical head 1. The number of signal output channels of the light-receiving elements 55a and 55b is smaller than that of the light-receiving elements 25a and 25b having the respective four split light-receiving regions E1 to H1 and E2 to H2 in the form of a matrix. As a result, the degree of freedom is increased in routing wirings from the light-receiving elements 55a and 55b to the error signal detection unit 31 and in selecting the location on the optical head 1 to provide the light-receiving elements 55a and 55b.

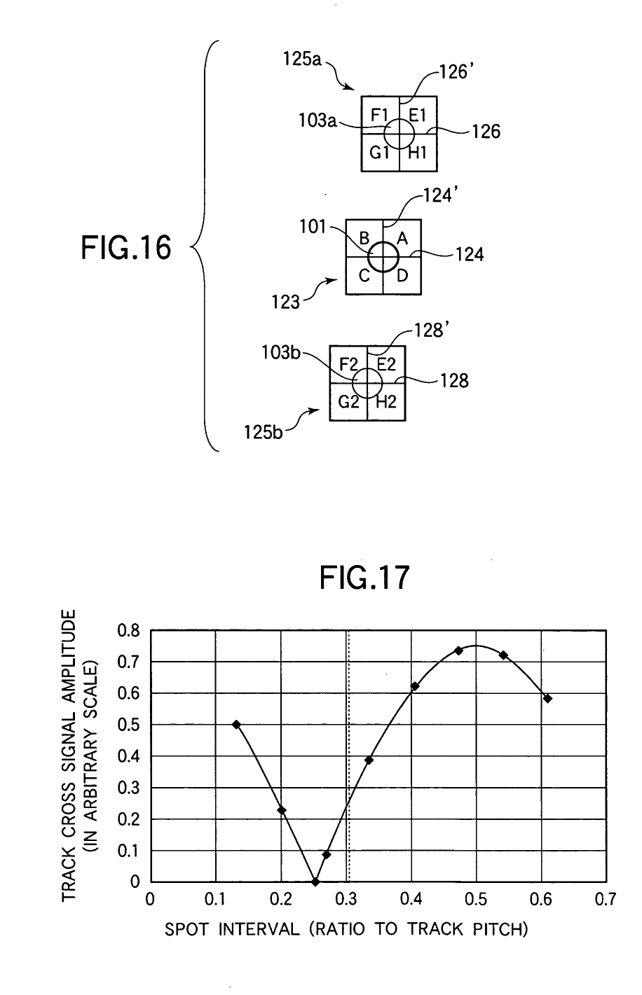

For example, it is possible to confirm that the main beam 27 and the sub beams 29a and 29b of orders of ±1 are located on one and the same track by observing the waveform of the signal having the highest frequency (RF signal) including recorded data among reproduction signals, the observation being triggered by the subbeam 29a of order of ±1. This is advantageous in that the adjustment of the angle of an optical beam can be easily performed at a step for manufacturing the optical head 1. In order to employ this method, it is essential that a reproduction signal can be detected when the sub beams 29a and 29b of orders of ±1 have not been added or that the signal can be detected from only the sub beam 29a of order of ±1. When there are three light-receiving elements 123, 125a, and 125b having four square light-receiving regions in the form of a matrix as shown in FIG. 16, it is difficult to detect electrical signals output based on the sub beams 29a and 29b of orders of ±1 separately because the number of electrodes is normally smaller than required for this purpose.

In the case of the optical recording/reproducing apparatus 150 of the present embodiment, however, since the number of signal out put channels of the light-receiving elements 55a and 55b is smaller than that of the light-receiving elements 125a and 125b having the matrix-like four split light-receiving regions E1 to H1 and E2 to H2, the number of electrode will not run short in most cases. The above-described method can therefore be used for the optical recording/reproducing apparatus 150, and the angle of alight beam can be easily adjusted at a step for manufacturing the optical head 1.

### Fourth Embodiment

A description will now be made on a method of detecting a focus error signal of an optical head and an optical head and an optical recording/reproducing apparatus utilizing the same according to a fourth embodiment of the invention. The schematic configurations of an optical head and an optical recording/reproducing apparatus of the present embodiment will not be described because they are schematically the same as those of the optical head 1 and the optical recording/reproducing apparatus 150 of the first embodiment. The interval between the spots of a main beam 27 and sub beams 29a and 29b from the optical head of the present embodiment is set at 0.39 μm that is an optimum value for the second optical recording medium 15b just as for the optical head 1 of the first embodiment.

In order to solve the problem of degradation of a reproduction signal because of a focus error (defocus) caused by a shift of the objective lens, the optical recording/reproducing apparatus 150 of the present embodiment is characterized in that a focus error signal is obtained by subtracting a differential push-pull signal (a second arithmetic signal) from an astigmatic signal (MFES), the differential push-pull signal being generated by performing an arithmetic process on a main beam and sub beams and having a smaller offset attributable to a shift of the objective lens. In the optical recording/reproducing apparatus of the present embodiment, a focus error signal is calculated according to the following arithmetic expression
FES=}(A+C)−(B+D)}+k4×[}(A+B)−(C+D)}−k5×{(E+F)−(G+H)}] Expression 12

The second term of Expression 12 of the expression in the bracket, i.e., [((A+B)−(C+D)}−}k5×{(E+F)−(G+H)}], is the same as that for a TES in Expression 9 except for the coefficient k5. Therefore, DC offset components generated by shifts of the objective lens in the radial direction of the medium can be eliminated from a differential push-pull signal obtained by the calculation of the second term of Expression 12 by adjusting the coefficient k5. The optical recording/reproducing apparatus can detect a focus error signal which has no DC offset component applied thereto and in which track cross signals have been attenuated because the signal is obtained by performing an arithmetic process between an MFES and a differential push-pull signal from which DC offset components have been eliminated.

A method for setting the coefficients k4 and k5 will now be described. The coefficient k5 is the same as the coefficient used for calculating a differential push-pull signal. That is, the coefficient k5 is set at such a value that DC offset components can be sufficiently eliminated. The coefficient k4 is optimized and set such that the value of a track cross signal included in a focus error signal is minimized. In the optical recording/reproducing apparatus of the present embodiment, when an optimum value of the coefficient k4 is identified, the value of the coefficient k5 should have already been decided. However, only focus servo is active at this stage, no shift of the objective lens occurs. Therefore, the coefficient k4 is optimized after setting an appropriate initial value of the coefficient k5, e.g., 1. Then, the coefficient k5 is optimized after the coefficient k4 is decided, and such a procedure allows the two gain coefficients k4 and k5 of Expression 12 to be finally decided. For example, the coefficients k4 and k5 are set at the stage of the self test described above in relation to the method of detecting a focus error signal from an optical head in the first embodiment of the invention.

A description will now be made on a configuration of an FES detecting portion which can perform the calculation shown in Expression 12. What is required for an FES detecting portion provided in the optical recording/reproducing apparatus of the present embodiment is that it includes a differential push-pull signal (DPPS) generating part similar to the TES detecting portion 44 in the first embodiment shown in FIG. 10 instead of the MPS generating part 37 of the FES detecting portion 33 in the first embodiment shown in FIG. 9. However, the DPPS generating part must have a differential amplifier having an amplification factor of k5 instead of the differential amplifier 47c of the TES detecting portion 44. Further, the DPPS generating part must have a differential amplifier having an amplification factor of k4 instead of the TES generating part 49 of the TES detecting portion 44. Thus, the FES detecting portion of the optical recording/reproducing apparatus of the present embodiment can perform the calculation shown in Expression 12.

A description will now be made on a modification of the method of detecting a focus error signal of an optical head and the optical head and the optical recording/reproducing apparatus employing the method in the present embodiment. An optical head of the present modification includes light-receiving elements 23, 55a, and 55b having patterns with eight divisions that are similar in configuration to the light-receiving elements 23, 55a, and 55b provided in the optical head 1 of the third embodiment. An optical recording/reproducing apparatus of the present modification calculates a focus error signal according to the following arithmetic expression.
FES={(A+C)−(B+D)}+k6×[}(A+B)−(C+D)}−{k7×{(I1+I2)−(J1+J2)}] Expression 13

By setting the coefficients k6 and k7 using the same method as for the coefficients k4 and k5 shown in Expression 12, the optical recording/reproducing apparatus of the present modification can be made to detect a focus error signal which has no DC offset components applied thereto and in which track cross signals have been attenuated. Thus, the optical recording/reproducing apparatus of the present modification can provide the same advantages as those of the optical recording/reproducing apparatus of the present embodiment. The positions of sub beams of orders of ±1 can be easily adjusted in the optical recording/reproducing apparatus of the present modification because it is loaded with the optical head having the light-receiving elements 23, 55a, and 55b in a pattern with eight divisions.

### Fifth Embodiment

A description will now be made on a method of detecting a focus error signal of an optical head and an optical head and an optical recording/reproducing apparatus employing the method according to a fifth embodiment of the invention. An optical head according to the present embodiment is characterized in that it employs a special diffraction grating having a wavy grating pattern as a diffracting element for forming sub beams of orders of ±1 on an information recording surface of an optical recording medium and in that the diameter of the spots of the sub beams of orders of ±1 in the radial direction of the medium is as great as 2.5 times or more of the diameter of the spot of the main beam in the radial direction. The configuration of the optical head of the present embodiment will not be described because it is similar to that of the optical heads in the first through the fourth embodiments except that the special diffraction grating is used instead of the diffraction grating 19. The configuration of an optical recording/reproducing apparatus according to the present embodiment will not be described because it is similar to that of the optical recording/reproducing apparatus in the first through the fourth embodiments.

For example, the special diffraction grating has a grating pattern having a grating pitch which changes on a predetermined cycle. When the grating pitch changes on a predetermined cycle, aberration can be imparted to light beams that exit the special diffraction grating other than a main beam. The use of the special diffraction grating makes it possible to provide sub beams of orders of ±1 converged on an information recording surface of an optical recording medium with a spot diameter in the radial direction greater than a spot diameter of the main beam in the radial direction.

When the sub beams of orders of ±1 have a great radial length, a cut-off frequency of an optical transfer coefficient of the sub beams of orders of ±1 is shifted to the lower side, and track cross signal components having a high spatial frequency (the inverse of the track pitch) are therefore eliminated. Therefore, sub beams of orders of ±1 reflected by the optical recording medium 15 are received by respective light-receiving elements, and an arithmetic process is performed on electrical signals output by the light-receiving elements. As a result, a focus error signal can be detected while suppressing entry of track cross signals to a smaller amount. A focus error signal is obtained using Expression 8, 10, or 12 when the light-receiving elements for receiving sub beams of orders of ±1 have four divisions. A focus error signal is obtained using Expression 11 or 13 when the light-receiving elements for receiving sub beams of orders of ±1 have two divisions.

The optical head of the present embodiment does not require the adjustment of the angle of sub beams of order of ±1 on an optical recording medium. Therefore, manufacturing steps can be simplified, and the manufacturing cost of an optical head and optical recording/reproducing apparatus can be reduced.

The invention is not limited by the above-described embodiments and may be modified in various ways.

In the optical recording/reproducing apparatus 150 of the first embodiment, a light beam emitted by the laser diode 3 is split by the diffraction grating 19 into a main beam 27 and sub beams 29a and 29b of orders of ±1, but this is not limiting the invention. The optical recording/reproducing apparatus 150 of the first embodiment can detect a focus error signal in which track cross signals have been attenuated using light received by a single light-receiving element. Therefore, in the case of only a focus error signal is to be detected, a focus error signal can be detected with track cross signals attenuated by converging a light beam on the information recording surface of the optical recording medium 15 without splitting it and by receiving the reflected light beam with a single light-receiving element.

In the optical head 1 of the first and the second embodiments, the wirings extended from the light-receiving regions E1, F1, G1, and G1 are connected to the wirings extended from the light-receiving regions E2, F2, G2, and H2 , respectively. However, the invention is not limited to such an arrangement. The wirings extended from the light-receiving regions E1 to G1 and E2 to H2 may be connected to the error signal detection unit 31 instead of being connected in the predetermined combinations.

In this case, the error signal detection unit 31 must have four adding parts for adding electrical signals output from the light-receiving regions E1 and E2, electrical signals output from the light-receiving regions G1 and G2, electrical signals output from the light-receiving regions F1 and F2, and electrical signals output from the light-receiving regions HI and H2, respectively. The four adding parts can output addition signals E1+E2, G1+G2, F1+F2, and G1+H2, respectively. The four addition signals may be connected to predetermined input terminals (+) of the adders 47a, 47b, 57a, and 57b to achieve connections similar to those in the TES detecting portion 44 shown in FIG. 10 and the FES detecting portion 53 shown in FIG. 12, which provides the same effects as those of the FES detecting portion 53 and the TES detecting portion 44 in the above-described embodiments.

The error signal detection unit 31 of the optical recording/reproducing apparatus 150 of the first, the second, and the third embodiments detects a focus error signal at the FES detecting portion 33 from either of the first and the second optical recording media 15a and 15b, but this is not limiting the invention. The interval between the spots of the main beam 27 and the sub beams 29a and 29b of orders of ±1 is adjusted to the optimum value for the second optical recording medium 15b. Therefore, in the case of the second optical recording medium 15b, a focus error signal may be detected using differential astigmatic focus error detection according to the related art as shown in Expression 1. The method of detecting a focus error signal can be switched for each of the first and the second optical recording media 15a and 15b to provide advantages similar to those of the optical recording/reproducing apparatus 150 in the above-described embodiments.

In the optical recording/reproducing apparatus 150 of the third embodiment, each of the wirings extended from the light-receiving regions I1, I2, J1, and J2 is connected to the error signal detection unit 31. However, the invention is not limited to such an arrangement. For example, light-receiving regions of the light-receiving elements 55a and 55b in the same relative position in the respective light-receiving areas (i.e., the light-receiving regions I1 and I2 and the light-receiving regions J1 and J2) may be connected. In this case, electrical signals output from the light-receiving regions I1 and I2, respectively, are at the same electrical potential, and electrical signals output from the light-receiving regions J1 and J2, respectively, are at the same electrical potential.

An electrical signal I1+I2 input to the error signal detection unit 31 from the wiring connecting the light-receiving regions I1 and I2 can be regarded identical to the output signal from each of the adder 47a shown in FIG. 10 and the adder 57a shown in FIG. 12. An electrical signal J1+J2 input to the error signal detection unit 31 from the wiring connecting the light-receiving regions J1 and J2 can be regarded identical to the output signal from each of the adder 47b shown in FIG. 10 and the adder 57b shown in FIG. 12. Therefore, the same advantages as those of the TES detecting portion 44 and the FES detecting portion 53 in the second embodiment can be achieved by connecting the wiring that connects the light-receiving regions I1 and I2 to the non-inverting input terminals (+) of the differential amplifiers 47c and 57c and by connecting the wiring that connects the light-receiving regions J1 and J2 to the inverting input terminals (−) of the differential amplifiers 47c and 57c.

The optical heads 1 in the first and the second embodiments include light-receiving elements 23, 25a, and 25b having four light-receiving regions disposed adjacent to each other in the form of a matrix, but this is not limiting the invention. For example, the light-receiving area of each of the light-receiving elements 23, 25a, and 25b may be divided into five or more regions. The same advantages as those of the optical heads 1 in the above-mentioned embodiments can be achieved also in this case.

What is claimed is:

1. A method of detecting a focus error signal of an optical head, comprising the steps of:
diffracting a light beam emitted by a light source to split the light beam into a main beam and two sub beams and converging the beams on an optical recording medium through an objective lens;
converting the main beam and the two sub beams reflected by the optical recording medium into electrical signals by receiving the main beam and the two sub beams, respectively, using three light-receiving areas which are divided into four regions by a first division line substantially in parallel with a direction along a tangent to a track of the optical recording medium and a second division line substantially orthogonal to the first division line; and
detecting a focus error signal in which a track cross signal generated when the objective lens moves across a track of the optical recording medium has been attenuated by subtracting a second arithmetic signal generated by performing an arithmetic process on the main beam and the two sub beams from a first arithmetic signal obtained by performing a differential operation between the electrical signals output by one of diagonal pairs of the light-receiving areas and output by the other pair of the light-receiving areas, respectively.

2. A method of detecting a focus error signal of an optical head according to claim 1, comprising the step of receiving the two sub beams reflected by the optical recording medium using two respective light-receiving areas divided into two regions by the first division line instead of the light-receiving areas divided into four regions to detect the focus error signal in which the track cross signal has been attenuated.

3. A method of detecting a focus error signal of an optical head according to claim 1, wherein the focus error signal in which the track cross signal has been attenuated is detected by adding the electrical signals output from the regions located in the same relative position in the light-receiving areas receiving the two sub beams respectively.

4. A method of detecting a focus error signal of an optical head according to claim 1, wherein, on the optical recording medium (a first optical recording medium) having a physical track pitch P1 in the radial direction of the optical recording medium or the optical recording medium (a second optical recording medium) having a physical track pitch P2 (P2<P1), the focus error signal in which the track cross signal has been attenuated is detected by positioning the spots of the two sub beams symmetrically about the spot of the main beam and in positions at a distance of about P2×(n+½) in the radial direction where n represents 0 or a greater integer.

5. A method of detecting a focus error signal of an optical head according to claim 1, wherein the focus error signal in which the track cross signal has been attenuated is detected by subtracting the second arithmetic signal from the first arithmetic signal after amplifying the second signal by a predetermined amount based on the ratio of the track cross signal included in each of the first and the second arithmetic signals.

6. An optical head diffracting a light beam emitted by a light source to split the light beam into a main beam and two sub beams and converging the beams on an optical recording medium through an objective lens, the optical head comprising:
a light-receiving area for the main beam divided into four regions by a first division line substantially in parallel with a direction along a tangent to a track of the optical recording medium and a second division line substantially orthogonal to the first division line for receiving the main beam reflected by the optical recording medium and converting the main beam into an electrical signal; and
two light-receiving areas divided into two regions by the first division line for receiving the two sub beams reflected by the optical recording medium respectively, wherein, on the optical recording medium (a first optical recording medium) having a physical track pitch P1 in the radial direction of the optical recording medium or the optical recording medium (a second optical recording medium) having the physical track pitch P2 (P2<P1), the spots of the two sub beams are positioned symmetrically about the spot of the main beam and in positions at a distance of about P2×(n+½) in the radial direction where n represents 0 or a greater integer.

7. An optical head according to claim 6, wherein the diameter of the spots of the two sub beams formed on a surface of the optical recording medium in the radial direction of the optical recording medium is 2.5 times or more of the diameter of the spot of the main beam in the same direction.

8. An optical recording/reproducing apparatus comprising:
an optical head having a diffraction grating for diffracting a light beam emitted by a light source to split the light beam into a main beam and two sub beams, and objective lens for converging the main beam and the two sub beams on an optical recording medium, and three light-receiving areas divided into four regions by a first division line substantially in parallel with a direction along a tangent to a track of the optical recording medium and a second division line substantially orthogonal to the first division line for receiving the main beam and the two sub beams reflected by the optical recording medium and converting the main beam and the two sub beams into electrical signals, respectively; and
an error signal detection unit for detecting a focus error signal in which a track cross signal generated when the objective lens moves across a track of the optical recording medium has been attenuated by subtracting a second arithmetic signal generated by performing an arithmetic process on the main beam and the two sub beams from a first arithmetic signal obtained by performing a differential operation between the electrical signals output by one of diagonal pairs of the light-receiving areas and output by the other pair of the light-receiving areas, respectively.

9. An optical recording/reproducing apparatus according to claim 8, wherein the optical head includes two light-receiving areas divided into two regions by the first division line for receiving the two sub beams reflected by the optical recording medium respectively instead of the light-receiving areas divided into four regions.

10. An optical recording/reproducing apparatus according to claim 8, wherein the error signal detection unit detects the focus error signal in which the track cross signal has been attenuated by adding the electrical signals output from light-receiving regions located in the same relative position in the light-receiving areas receiving the two sub beams respectively.

11. An optical recording/reproducing apparatus according to claim 8, wherein the error signal detection unit detects the focus error signal in which the track cross signal has been attenuated by subtracting the second arithmetic signal from the first arithmetic signal after amplifying the second signal by a predetermined amount based on the ratio of the track cross signal included in each of the first and the second arithmetic signals.

12. An optical recording/reproducing apparatus according to claim 8, wherein, on the optical recording medium (a first optical recording medium) having a physical track pitch P1 in the radial direction of the optical recording medium or the optical recording medium (a second optical recording medium) having the physical track pitch P2 (P2<P1), the spots of the two sub beams are positioned symmetrically about the spot of the main beam and in positions at a distance of about P2×(n+½) in the radial direction where n represents 0 or a greater integer.

13. An optical recording/reproducing apparatus according to claim 8, wherein the diameter of the spots of the two sub beams formed on a surface of the optical recording medium in the radial direction of the optical recording medium is 2.5 times or more of the diameter of the spot of the main beam in the same direction.
